(19) United States
(12) Patent Application Publication
(10) Pub. No.: US 2012/0133871 A1
(43) Pub. Date: May 31, 2012

(54) RETARDATION FILM BASED ON OPTICALLY ALIGNED LIQUID CRYSTALLINE POLYIMIDE AND OPTICAL DEVICE

(75) Inventors: Kazuhiko Saigusa, Ichihara-shi (JP); Norio Tamura, Ichihara-shi (JP)

(73) Assignees: JNC Petrochemical Corporation, Tokyo (JP); JNC Corporation, Tokyo (JP)

(21) Appl. No.: 13/380,522

(22) PCT Filed: Jun. 17, 2010
(86) PCT No.: PCT/JP2010/060263

§ 371 Date: Feb. 6, 2012

(30) Foreign Application Priority Data
Jun. 25, 2009 (JP) 2009-150914

(51) Int. Cl. G02F 1/1335; G02F 1/13

(52) U.S. Cl. 349/108; 349/117; 349/193

(57) ABSTRACT

Provided is a technology by which a retardation film in which regions different from each other in one or both of optical characteristics, i.e., an optical axis and a retardation are patterned can be produced with an additionally small load. The retardation film is formed of a liquid crystalline polyimide film having a photoreactive group. Further provided is an optical device and a liquid crystal display apparatus each having the retardation film.

### TECHNICAL FIELD

The present invention relates to a retardation film produced by using a liquid crystalline polyimide having a photoreactive group in which a plurality of regions different from each other in optical characteristic, i.e., an optical axis or a retardation are patterned, and an optical device and a liquid crystal display apparatus each having the retardation film.

### BACKGROUND ART

Retardation films have been utilized in optical devices such as a pickup optical system and an optical device for anti-counterfeit in addition to a liquid crystal display apparatus because each of the films has a function of transforming a polarization state before the passing of the film into another different polarization state by virtue of its optical characteristics such as the magnitude of its retardation and the axial angle of its optical axis.

Further, the patterning of each of the retardation films by changing the optical characteristics such as the magnitude of the retardation and the axial angle of the optical axis for each predetermined region (which may hereinafter be referred to as “patterned retardation film”) has been expected to lead to an improvement in the performance of any such optical device as described in the foregoing and the creation of a unique optical device.

Most of the retardation films have been currently obtained by stretching thermoplastic resins typified by a polycarbonate resin and a cyclic olefin-based resin. However, it is difficult to obtain the patterned retardation film by the approach.

An approach for obtaining the patterned retardation film through the change of the axial angle of the optical axis is, for example, the utilization of a composition containing a liquid crystal compound provided with a polymerizable functional group for immobilizing its alignment (which may hereinafter be referred to as “polymerizable liquid crystal material”) and a film provided with an anchoring energy for aligning a liquid crystal molecule in a specific direction by being irradiated with light such as polarized ultraviolet light (which may hereinafter be referred to as “optical alignment film”) (see, for example, Patent Document 1). According to Patent Document 1, a retardation film in which regions having different optical axes are patterned is obtained by applying the polymerizable liquid crystal material onto the optical alignment film a predetermined region of which has been irradiated with polarized ultraviolet light in a specific orientation to arrange its alignment and curing the material. However, the approach requires another technology for patterning concerning the retardation as an optical characteristic different from the optical axis.

In addition, a method involving using a polymerizable liquid crystal material containing a photoisomerizable compound has been known as an approach for obtaining the patterned retardation film through the change of the retardation (see, for example, Patent Document 2). The method is, for example, such that the photoisomerizable compound in the polymerizable liquid crystal material undergoes photoisomerization from a trans isomer to a cis isomer by photoirradiation and a ratio of the cis isomer to the trans isomer increases as the dose of light increases. In such polymerizable liquid crystal material containing the photoisomerizable compound, its birefringence reduces as the dose of light increases, that is, the ratio of the cis isomer to the trans isomer in the photoisomerizable compound increases. Therefore, a retardation film in which regions having different magnitudes of retardations are patterned is obtained by changing the photoirradiation for each predetermined region. However, the technology also requires another technology for the patterning of the optical axis as an optical characteristic different from the retardation.

As described above, the utilization of the polymerizable liquid crystal material is useful in the production of the patterned retardation film. However, a substrate must be provided with an alignment film provided with an anchoring energy by being subjected to a rubbing treatment or irradiation with polarized ultraviolet light for uniformly aligning liquid crystal molecules, and hence a material and a production step for the film are separately needed. In addition, the production of a retardation film in which both an optical axis and a retardation are patterned can be achieved by combining the technologies of Patent Documents 1 and 2, but it is apparent that a production step becomes additionally complicated. In view of the foregoing, an approach with an additionally small production load has been requested for its mass production.

As described in the foregoing, a retardation film has been utilized in a liquid crystal display apparatus. Specific examples of the film and its problems to be solved are given below. The so-called ¼λ plate is used in a reflective liquid crystal display apparatus or a semitransmission liquid crystal display apparatus. The ¼λ plate is a retardation film whose retardation has a magnitude of a quarter of a specific wavelength λ for the wavelength λ, provided that it is not easy to obtain a retardation film having such characteristic for any wavelength in a visible light region. In view of the foregoing, a retardation film whose retardation has a magnitude adjusted to a quarter of a representative wavelength λₘ for the wavelength λₘ is used. However, the magnitude of the retardation differs from an ideal one at a wavelength except λₘ, and hence a liquid crystal display apparatus mounted with the film cannot obtain sufficiently satisfactory values for characteristics concerning the performance of the display apparatus such as a contrast ratio.

The following approach is effective in solving the problem in a liquid crystal display apparatus mounted with a color filter in which the pattern of a plurality of color filter layers having different spectral transmittance characteristics is formed. A retardation film the magnitude of the retardation of which is adjusted to λ₁/4, λ₂/4, . . . , or λₘ/4 for a representative wavelength λ₁, λ₂, . . . , or λₘ in a wavelength band corresponding to each color filter layer is patterned in correspondence with the color filter layers having different spectral transmittance characteristics in the color filter. Further, in consideration of an influence of parallax, it is desirable that the patterned retardation film be formed on the color filter layers and be placed inside a liquid crystal panel.

Further, when the patterned retardation film is formed on the color filter layers, an overcoat, an electrode, and an alignment film for a driving liquid crystal are formed on the patterned retardation film upon production of the liquid crystal panel. Accordingly, the patterned retardation film is requested to have such heat resistance that the characteristics of the retardation film do not change beyond their allowable ranges with the treatment temperature and thermal hysteresis of a process for producing any one of the overcoat, the electrode, and the alignment film.

### CITATION LIST

### Patent Documents

[Patent Document 1] Japanese Patent Translation Publication No. 2001-525080
[Patent Document 2] Japanese Patent Translation Publication No. 2006-526165

### SUMMARY OF INVENTION

### Technical Problem

The present invention provides a technology by which a retardation film in which regions different from each other in one or both of optical characteristics, i.e., an optical axis and a retardation are patterned can be produced with an additionally small load. Further, the present invention provides an optical device and a liquid crystal display device each using the patterned retardation film.

### Solution to Problem

The inventors of the present invention have found a specific structure of a polyamic acid that expresses thermotropic liquid crystallinity by being heated and imidated, and has optical alignment property, and have found that a thin film obtained by optically aligning, heating, and imidating the polyamic acid in a coating film thereof can be utilized as a retardation film as well by virtue of large optical anisotropy obtained by the liquid crystallinity expressed by the imidation. Further, the inventors have found that optical characteristics in the thin film as a retardation film such as the axial angle of an optical axis and the magnitude of a retardation can be controlled by irradiating the coating film with light while controlling the polarization state, and irradiation energy intensity, of light to be optically aligned. Thus, the inventors have completed the present invention.

That is, the present invention provides a retardation film, being formed of a material containing a polyimide that has a photoreactive group and shows liquid crystallinity.

Further, the present invention provides the above-mentioned retardation film, in which a pattern formed of at least two regions different from each other in one or both of an orientation of an optical axis and a retardation is formed.

Further, the present invention provides the above-mentioned retardation film, in which the film is obtained by irradiation with light beams in different polarization states.

Further, the present invention provides the above-mentioned retardation film, in which the film is obtained by irradiation with light in an arbitrary polarization state at different illuminances or different irradiation energy intensities.

Further, the present invention provides the above-mentioned retardation film, in which the film is obtained by forming different thicknesses.

Further, the present invention provides the above-mentioned retardation film, in which the film is obtained by combining at least two of the following approaches: (1) irradiation with light beams in different polarization states; (2) irradiation with light having an arbitrary polarization state at different illuminances or different irradiation energy intensities; and (3) formation of different thicknesses.

Further, the present invention provides the above-mentioned retardation film, in which the liquid crystalline polyimide film is a polyimide film caused to express optical anisotropy by photoirradiation and baking of a polyamic acid that has a photoreactive group and expresses liquid crystallinity by being imidated.

Further, the present invention provides an optical device, including the above-mentioned retardation film of the present invention.

Further, the present invention provides the above-mentioned optical device, including: a patterned retardation film in which a pattern formed of at least two regions different from each other in one or both of an orientation of an optical axis and a magnitude of a retardation is formed; and a non-patterned retardation film in which an orientation of an optical axis and a magnitude of a retardation are uniform, in which the patterned retardation film is the above-mentioned retardation film of the present invention.

Further, the present invention provides the above-mentioned optical device, in which at least one layer of the non-patterned retardation film is a film in which an alignment state of a liquid crystal compound having a polymerizable functional group is immobilized by crosslinking or polymerization of the liquid crystal compound.

Further, the present invention provides the above-mentioned optical device, in which the non-patterned retardation film, in which the alignment state of the liquid crystal compound is immobilized by the crosslinking or the polymerization is directly formed on the patterned retardation film.

Further, the present invention provides the above-mentioned optical device, in which: the patterned retardation film is a patterned retardation film whose surface is rubbed or is irradiated with ultraviolet light; and the non-patterned retardation film in which the alignment state of the liquid crystal compound is immobilized by the crosslinking or the polymerization is formed thereon.

Further, the present invention provides the above-mentioned optical device, in which the alignment state of the liquid crystal compound is horizontal alignment.

Further, the present invention provides the above-mentioned optical device, in which the alignment state of the liquid crystal compound is spray alignment or hybrid alignment.

Further, the present invention provides the above-mentioned optical device, in which the alignment state of the liquid crystal compound is vertical alignment.

Further, the present invention provides the above-mentioned optical device, in which the alignment state of the liquid crystal compound is spirally distorted alignment.

Further, the present invention provides the above-mentioned optical device, in which the element is an anti-counterfeit device.

Further, the present invention provides a display apparatus, including the above-mentioned retardation film of the present invention.

Further, the present invention provides a liquid crystal display apparatus, including the above-mentioned retardation film of the present invention.

Further, the present invention provides the above-mentioned liquid crystal display apparatus, further including a color filter for selectively transmitting light in a specific wavelength range, in which: the color filter has color filter layers for selectively and independently transmitting light beams in two or more specific wavelength ranges, and a retardation film provided in correspondence with the color filter layers for each pixel; and the retardation film is the above-mentioned retardation film of the present invention.

Further, the present invention provides the above-mentioned liquid crystal display apparatus, in which the retardation film is a retardation film in which a pattern formed of two or more regions different from each other in one or both of an orientation of an optical axis and a magnitude of a retardation is formed in correspondence with respective regions of the color filter layers for selectively transmitting the light beams in the specific wavelength ranges.

Further, the present invention provides the above-mentioned liquid crystal display apparatus, the apparatus being a semitransmission-type liquid crystal display apparatus having a region provided with a reflective plate and a region free of being provided with any reflective plate for each pixel, in which the retardation film is a retardation film in which a pattern formed of two or more regions different from each other in one or both of an orientation of an optical axis and a magnitude of a retardation is formed in correspondence with the region provided with the reflective plate and the region free of being provided with any reflective plate.

Further, the present invention provides the above-mentioned liquid crystal display apparatus, in which: the color filter is a color filter in which a pattern formed of two or more regions of the color filter layers for selectively transmitting the light beams in the specific wavelength ranges is formed; and the retardation film includes a retardation film in which a pattern formed of two or more regions different from each other in one or both of an orientation of an optical axis and a magnitude of a retardation is formed in further correspondence with respective regions of the color filter layers having different spectral transmittance characteristics.

### Advantageous Effects of Invention

According to the present invention, optical characteristics, that is, the orientation (axial angle) of an optical axis and the magnitude of a retardation can be adjusted depending on the polarization state, irradiation energy intensity, and the like of light to be applied to a film of a polyamic acid before being heated and imidated. In addition, a retardation film having high heat resistance peculiar to a polyimide is obtained. Therefore, the present invention can provide a technology by which a retardation film in which regions different from each other in one or both of the axial angle of an optical axis and the magnitude of a retardation are patterned can be produced with additionally small numbers of members and steps. Further, the present invention can provide each of an optical device and a liquid crystal display device each using the patterned retardation film as well with additionally small numbers of members and steps.

### BRIEF DESCRIPTION OF DRAWINGS

FIG. 1 is a view illustrating axial directions in refractive indices nx, ny, and nz in three directions.

FIG. 2 is a view illustrating the axial angles of an optical axis and an absorption axis.

FIG. 3 is a view illustrating an incidence plane, an azimuth angle, and a polar angle.

FIG. 4 is a view illustrating an example of an anti-counterfeit device in the present invention.

FIG. 5 is a view illustrating the manner in which the anti-counterfeit device of FIG. 4 is observed without through any special filter.

FIG. 6 is a view illustrating an example of a special filter.

FIG. 7 is a view illustrating the manner in which the anti-counterfeit device of FIG. 4 is observed through the special filter.

FIG. 8 is a view illustrating a modification example of the anti-counterfeit device of FIG. 4.

FIG. 9 is a view illustrating another example of the anti-counterfeit device in the present invention.

FIG. 10 is a view illustrating the manner in which the anti-counterfeit device of FIG. 9 is observed without through any special filter.

FIG. 11 is a view illustrating an example of the manner in which the anti-counterfeit device of FIG. 9 is observed through the special filter.

FIG. 12 is a view illustrating another example of the manner in which the anti-counterfeit device of FIG. 9 is observed through the special filter.

FIG. 13 is a view illustrating the anti-counterfeit device of FIG. 9 in a production process involving using a support.

FIG. 14 is a view illustrating an example of a stereo image display apparatus in the present invention.

FIG. 15 is a view illustrating an example of a reflective liquid crystal display apparatus in the present invention.

FIG. 16 is a view illustrating another example of the reflective liquid crystal display apparatus in the present invention.

FIG. 17 is a view illustrating an example of a transmission-type liquid crystal display apparatus in the present invention.

FIG. 18 is a view illustrating another example of the transmission-type liquid crystal display apparatus in the present invention.

FIG. 19 is a view illustrating an example of a semi-reflective liquid crystal display apparatus in the present invention.

FIG. 20 is a view showing a relationship between an irradiation energy intensity and a birefringence in a retardation film of Example 1.

FIG. 21 is a view showing the spectral transmittance characteristics of Comparative Example 1 and Invention Example 2 of Example 5.

FIG. 22 is a view showing the spectral transmittance characteristics of Comparative Example 3 and Invention Example 6 of Example 6.

### DESCRIPTION OF EMBODIMENTS

A retardation film of the present invention is formed of a material containing a polyimide that has a photoreactive group and shows liquid crystallinity (which may hereinafter be referred to as “liquid crystalline polyimide”).

<Liquid Crystalline Polyimide Containing Photoreactive Group>

The term “liquid crystalline polyimide” is a generic name for the following liquid crystalline polyimide. The polyimide has a photoreactive group on its main chain or a side chain thereof, and shows liquid crystallinity such as thermotropic liquid crystallinity or lyotropic liquid crystallinity. Although specific structures of the liquid crystalline polyimide are given below, the following specific examples do not limit the scope of the present invention.

Although the average molecular weight of the liquid crystalline polyimide is not particularly limited, its weight-average molecular weight is preferably 5×10³ or more, more preferably 1×10⁴ or more from the viewpoints of the prevention of the evaporation of the liquid crystalline polyimide during the baking of a coating film and the expression of preferred physical properties in the material. In addition, the weight-average molecular weight is preferably 1×10⁶ or less from such a viewpoint that the handling of the material in terms of, for example, viscosity is facilitated.

The weight-average molecular weight of the liquid crystalline polyimide is measured by a gel permeation chromatography (GPC) method. For example, the weight-average molecular weight is determined by: diluting the liquid crystalline polyimide or a polyamic acid as a precursor thereof with dimethylformamide (DMF) so that the concentration of the liquid crystalline polyimide or the precursor thereof may be about 1 wt %; measuring the weight-average molecular weight of the diluted solution with, for example, a CHROMATOPAC C-R7A (manufactured by Shimadzu Corporation) and with DMF as a developing solvent by the gel permeation chromatography (GPC) method; and converting the resultant value in terms of polystyrene. Further, a developing solvent prepared by dissolving an inorganic acid such as phosphoric acid, hydrochloric acid, nitric acid, or sulfuric acid, or an inorganic salt such as lithium bromide or lithium chloride in a DMF solvent may be used from the viewpoint of an improvement in the accuracy of the GPC measurement.

The photoreactive group is a group that aligns a specific molecular structure in the liquid crystalline polyimide such as a mesogen group toward one direction by irradiation with specific light. The number of photoreactive groups may be one, or may be two or more. For example, azobenzene has been known to undergo the following photoisomerization reaction. When azobenzene is irradiated with linearly polarized light in a wavelength range of 300 to 400 nm, azobenzene changes into a trans isomer having the long axis of the molecular structure of azobenzene in a direction perpendicular to the polarization direction. Such a group that changes into a specific structure by a photoisomerization reaction or a photocrosslinking reaction through irradiation with specific light as described above can be used as the photoreactive group. A photoreactive group that undergoes a photoisomerization reaction is, for example, an azo group as a group containing a double bond between nitrogen atoms, a vinylene group as a group containing a double bond between carbon atoms, or an ethynyl group as a group containing a triple bond between carbon atoms. A photoreactive group that undergoes a photocrosslinking reaction is, for example, a group having a cinnamic acid structure, a group having a coumaric acid structure, or a group having chalconic acid. The photoreactive group is preferably the photoreactive group that undergoes a photoisomerization reaction.

The content of the photoreactive group in the liquid crystalline polyimide is preferably 10 to 50 mol % with respect to an imide group in the liquid crystalline polyimide from such a viewpoint that the retardation film of the present invention is caused to express desired optical anisotropy, for example, such a viewpoint that the mesogen group is aligned in a predetermined direction depending on light to be applied.

The liquid crystalline polyimide is constructed of the photoreactive group, the mesogen group as a rigid molecular structure, and a spacer group as a flexible molecular structure. A main chain-type liquid crystalline polyimide can be constructed by constructing a main chain containing the photoreactive group, the mesogen group, and the spacer group, and a side chain-type liquid crystalline polyimide can be constructed by constructing a side chain containing the photoreactive group, the mesogen group, and the spacer group. Known structures can be adopted as the mesogen group and the spacer group. Examples of the mesogen group include groups each containing an aromatic imide ring, azobenzene, biphenyl, phenyl benzoate, azoxybenzene, stilbene, or terphenyl. The spacer group is, for example, a linear alkyl group having about 1 to 20 carbon atoms.

The retardation film of the present invention can be obtained by: forming a coating film of a solution of the liquid crystalline polyimide or a precursor thereof; irradiating the formed coating film with specific light to align the liquid crystalline polyimide or the precursor thereof by a reaction based on the photoreactive group; and baking the optically aligned coating film. The liquid crystalline polyimide or the precursor thereof has only to be a compound that is optically aligned by being irradiated with specific light in the coating film. In addition, the liquid crystalline polyimide is a polyimide showing liquid crystallinity at least during a time period commencing on the optical alignment and ending on the formation of the retardation film, and may be a polyimide showing liquid crystallinity in the solution or the coating film, or may be a polyimide showing liquid crystallinity during the baking, that is, in the film heated to a certain temperature or more. The liquid crystalline polyimide is, for example, a polyimide that has the photoreactive group and a mesogen structure, and dissolves in a solvent to be described later at a concentration of 1 wt % or more. The precursor of the liquid crystalline polyimide is, for example, a polyamic acid having the photoreactive group and the mesogen structure.

It should be noted that the concentration of the liquid crystalline polyimide can be determined depending on applications of the retardation film of the present invention. For example, the retardation film of the present invention may find use in an application where a retardation as small as about 10 nm is required. In this case, it is probably sufficient that the thickness of the retardation film is about 30 nm by virtue of the birefringence of its material. On the basis of the formation of a coating film having a thickness of such order, a lower limit for the concentration of the liquid crystalline polyimide can be set to 1 wt % as described in the foregoing.

In the present invention, the axial angle of the optical axis or the magnitude of the retardation in the retardation film can be adjusted by irradiating the coating film with specific light.

For example, in the present invention, vertical application of linearly polarized light to the coating film can provide a retardation film whose optical axis is parallel to the polarization direction of the applied light. In addition, in the present invention, vertical application of elliptically polarized light to the coating film can provide a retardation film whose optical axis is parallel to the long axis direction of the elliptically polarized light. Further, in the present invention, vertical application of unpolarized light to the coating film can provide a retardation film (polyimide film) the orientation of the optical axis of which is not specified.

In addition, for example, in the present invention, the magnitude of a birefringence Δn of the retardation film can be adjusted, and the magnitude of a retardation Re of the retardation film can also be adjusted in proportion to the irradiation energy intensity of the light to be applied to the coating film. That is, the Δn or the Re can be enlarged by enlarging the irradiation energy intensity of the light to be applied to the coating film, and the Δn or the Re can be reduced by reducing the irradiation energy intensity of the light to be applied to the coating film.

In addition, for example, in the present invention, the magnitude of the Re can be adjusted in proportion to the thickness of the retardation film. That is, the Re can be enlarged by enlarging the thickness of the retardation film, and the Re can be reduced by reducing the thickness of the retardation film. The thickness of the retardation film can be adjusted depending on, for example, the viscosity or concentration of a solution of the liquid crystalline polyimide or a solution of the precursor thereof, or the number of times of application of any such solution, and the thickness can be enlarged by increasing at least one of the viscosity, the concentration, and the number. Further, in the present invention, the Re or the Δn can be adjusted by using two or more kinds of the liquid crystalline polyimides in combination.

The light to be applied to the coating film for optical alignment has only to be light that prompts the photoreactive group described in the foregoing to cause a reaction for changing the orientation of the liquid crystalline polyimide. Such light is, for example, light (ultraviolet light) having a wavelength of 300 to 400 nm. The irradiation energy intensity of the applied light is preferably less than 10 J/cm² from, for example, such a viewpoint that moderate alignment is imparted to the polyamic acid.

The optical characteristics of the retardation film of the present invention can be adjusted by irradiation with light. Accordingly, a plurality of regions having different optical characteristics can be easily and precisely formed in the same film by controlling the polarization state, or irradiation energy intensity, of light to be applied together with a masking technology such as a photomask.

In addition, when a liquid crystal layer is formed on the retardation film of the present invention, the retardation film can align a liquid crystal compound along the orientation of the optical axis of the liquid crystalline polyimide. Further, when a liquid crystal layer is formed on the retardation film of the present invention after the surface of the retardation film has been subjected to a rubbing treatment, a liquid crystal compound can be aligned along the rubbing direction irrespective of the orientation of the optical axis of the liquid crystalline polyimide.

In addition, when a liquid crystal layer is formed on the retardation film of the present invention after the surface of the retardation film has been irradiated with ultraviolet light, the pretilt angle of a liquid crystal compound in the liquid crystal layer can be adjusted by mixing, into a solution of the precursor of the liquid crystalline polyimide, a polyamic acid having a diamine having a specific structure (side chain structure) that provides the pretilt angle of the liquid crystal compound as described in Japanese Patent Application Laid-open No. 2009-69493. Further, in the retardation film of the present invention, the pretilt angle can be reduced by irradiating a coating film of the solution with specific polarized ultraviolet light (such as polarized ultraviolet light having a wavelength as short as 300 nm or less).

Further, the retardation film of the present invention can find use in various applications such as an A-plate, a ¼λ plate, a ½λ plate, an optical compensation film, and a polarization rotator in each of which the liquid crystalline polyimide has uniaxiality and has an optical axis in a film surface as in a known retardation film by adjusting its optical characteristics to proper characteristics in accordance with the applications of the retardation film by the various approaches described in the forgoing.

In addition, the retardation film of the present invention has high heat resistance because the film is a polyimide film. Further, the retardation film has a stable optical characteristic that changes to a small extent even after the application of a thermal load exceeding 200° C. Therefore, in an optical device in which other one or two or more layers such as a film are further formed on the retardation film, the retardation film can resist even a production environment for the optical device where a baking step to be performed for forming these layers is repeatedly performed, and hence can be applied to a wide variety of optical devices such as a liquid crystal display device.

In addition, in the present invention, a plurality of regions different from each other in optical characteristic, i.e., the orientation of an optical axis or the magnitude of a retardation can be formed in the same plane of the retardation film by a production method with smaller numbers of members and steps than those of a conventional production method for a retardation film based on an alignment film and a liquid crystalline material.

(Preferred Examples of Polyamic Acid Having Photoreactive Group as Precursor of Liquid Crystalline Polyimide Having Photoreactive Group)

Next, specific examples of the liquid crystalline polyimide having a photoreactive group of the present invention are described. A preferred example thereof is a composition containing at least one polymer selected from a polyamic acid having a photoreactive group on its main chain and a polyimide obtained by the dehydration reaction of the acid, the composition having the following feature: the composition has a liquid crystal temperature range between 100° C. and 300° C. Table 1 shows compounds, i.e., a diamine and an acid anhydride that construct a polyamic acid having such feature, and Table 2 shows examples of the combination of the compounds.

TABLE 1

| | Diamine | Acid anhydride |
|---|---|---|
| Polyamic | At least one of diamine | At least one of acid |
| acid 1 | group I | anhydride group I |
| Polyamic | At least one of diamine | At least one of acid |
| acid 2 | group II | anhydride group II |
| Polyamic | Mixture of at least one | At least one of acid anhydride |
| acid 3 | of diamine group I and | group I (corresponding to |
| | at least one of diamine | diamine group I or III), or at |
| | group II or diamine | least one of acid anhydride |
| | group III | group II (corresponding to |
| | | diamine group II) |
| Polyamic | At least one of diamine | Mixture of at least one of acid |
| acid 4 | group II | anhydride group I and at least |
| | | one of acid anhydride group II |

TABLE 2

| Diamine | Acid anhydride |
|---|---|
| Diamine group I | Acid anhydride group I |
| Diamine having photoreactive | Acid anhydride free of any |
| group | photoreactive group |
| Compounds (I-1) to (I-3), (II-1) to | Formulae (VII-4) and (VII-5) |
| (II-3), (III-1), (IV-1) to (IV-3), | |
| (V-1), and (VI-1) to (VI-6) | |
| Diamine group II | Acid anhydride group II |
| Diamine free of any photoreactive | Acid anhydride having |
| group | photoreactive group |
| Formulae (VII-1) to (VII-3) | Compounds (IV-4) and (VI-8) |
| Diamine group III | Acid anhydride group III |
| Diamine free of any photoreactive | Acid anhydride free of any |
| group | photoreactive group |
| Compounds (VIII-1) to (VIII-5) | Compounds (VIII-7) and (VIII-8) |

[Chem. 1] 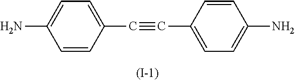 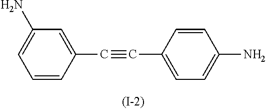 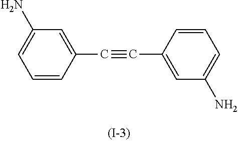 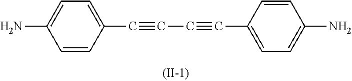 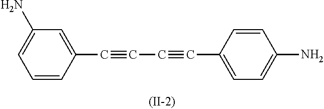 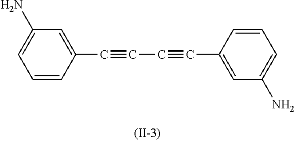
[Chem. 2] 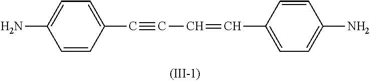 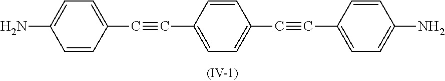 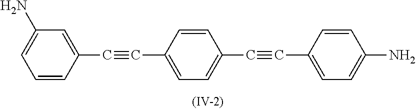 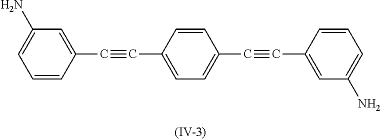 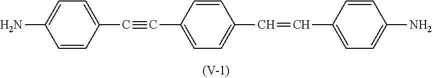
[Chem. 3] 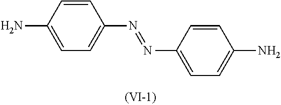 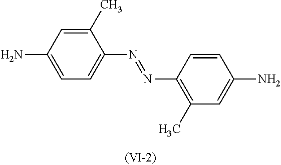 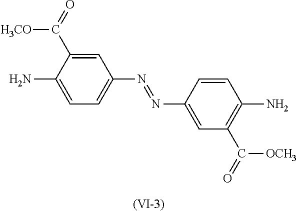 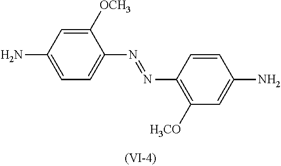 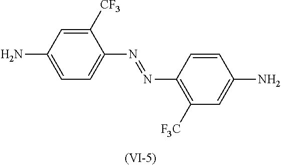 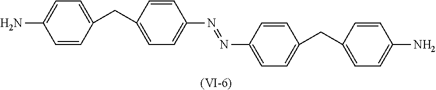
[Chem. 4]

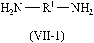

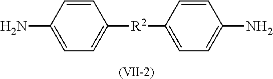

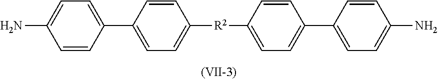

In the formula (VII-1), R¹ represents an alkylene having 6 to 20 carbon atoms. The number of carbon atoms is preferably 6 to 12. In addition, in the formulae (VII-2) and (VII-3), R² represents an alkylene having 6 to 20 carbon atoms in which one —CH₂— may, or two —CH₂—'s not adjacent to each other may each, be substituted with —O—, —NH—, —N(CH₃)—, —Si (CH₃)₂OSi (CH₃)₂— or —COO—.

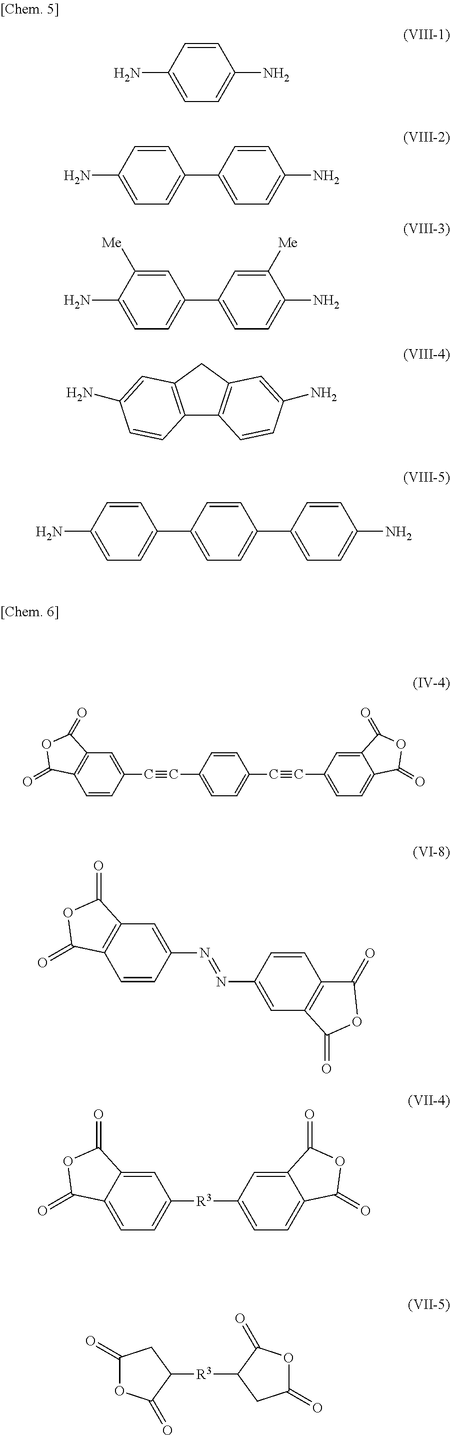

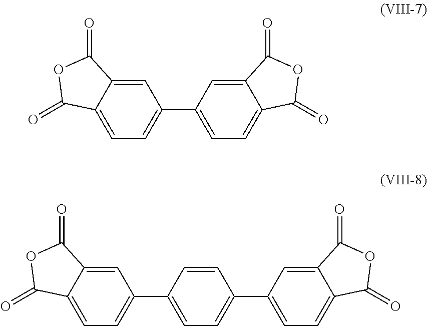

In the formulae (VII-4) and (VII-5), R³ represents an alkylene having 6 to 20 carbon atoms in which one —CH₂— may, or two —CH₂—'s not adjacent to each other may each, be substituted with —O—, —NH—, —N(CH₃)—, —Si (CH₃)₂OSi (CH₃)₂—, or —COO—.

The liquid crystalline polyimide having a photoreactive group of the present invention is, for example, a material containing a polyimide obtained by the dehydration reaction of a polyamic acid selected from the above-mentioned four preferred polyamic acids. The number of polyamic acids to be selected may be two or more.

In addition, in the present invention, a diamine except the diamines listed in the foregoing description or an acid anhydride except the acid anhydrides listed in the foregoing description can be used in combination. Examples of the diamine that can be used in combination include diamines described in the paragraphs 0077 to 0098 of Japanese Patent Application Laid-open No. 2009-69493. In addition, examples of the acid anhydride that can be used in combination include acid anhydrides described in the paragraphs 0103 to 0125 of Japanese Patent Application Laid-open No. 2009-69493 as in the foregoing.

The examples of the acid anhydride that can be used in combination further include compounds represented by formulae (IX-1) to (IX-4). A polyamic acid containing a structure based on any such acid anhydride is preferred from the viewpoint of an improvement in the solubility of even a polyimide obtained by imidating the acid in a solvent.

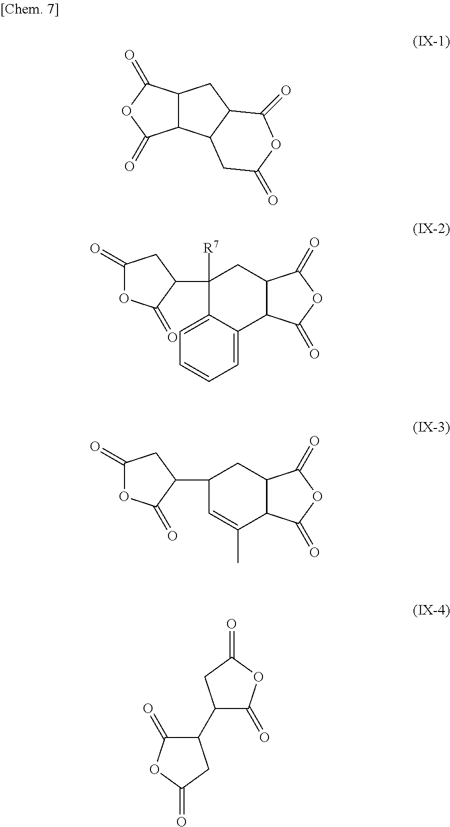

In the formula (IX-2), R⁷ represents hydrogen or a methyl group.

For example, the polyamic acid can adopt various compositions from the viewpoints of desired characteristics upon utilization of its function as a retardation film or a combination of its two functions as a retardation film and an alignment film. For example, the polyamic acid may be such a copolymer that the diamine is formed of a diamine having a photoreactive group and a diamine free of any photoreactive group, or may be such a copolymer that the acid anhydride is formed of an acid anhydride having a photoreactive group and an acid anhydride free of any photoreactive group. Further, a mixture of polyamic acids having two or more kinds of photoreactive groups, or a mixture of a polyamic acid having a photoreactive group and a polyamic acid free of any photoreactive group can be used as the polyamic acid.

The content of the photoreactive group in the polyamic acid is more preferably 10 to 50 mol % with respect to an imide group of the polyamic acid when it is assumed that 100% of the polyamic acid is imidated from such a viewpoint that a mesogen group is aligned in a predetermined direction in accordance with polarized light to be applied.

(Addition of Material Different from Preferred Polyamic Acid)

In the present invention, a material except the liquid crystalline polyimide or the precursor thereof (which may hereinafter be referred to as “additive”) can be further incorporated into a material for forming the coating film containing the liquid crystalline polyimide or the precursor thereof to such an extent that the liquid crystallinity of the liquid crystalline polyimide is obtained. The number of kinds of additives may be one, or may be two or more. For example, when the liquid crystalline polyimide or the precursor thereof is any one of the four polyamic acids listed above, the additive can be incorporated in a total amount of up to less than 50 parts by weight with respect to 100 parts by weight of the polyamic acid into the material to such an extent that such feature that the liquid crystalline polyimide has a liquid crystal temperature range between 100° C. and 300° C. is obtained.

(Polyamic Acid Free of any Photoreactive Group)

In the present invention, a polyamic acid containing no photoreactive group may be incorporated as the additive into the material. Examples of such polyamic acid include a linear polyamic acid and a polyamic acid having a side chain structure. Any such polyamic acid can be added from the viewpoint of an improvement in an electrical characteristic or alignment characteristic of the retardation film to be obtained, or an improvement or change in the alignment characteristic of a liquid crystal upon, for example, utilization of the film as an alignment film for a driving liquid crystal medium or a liquid crystalline material as well.

(Non-Polyimide-Based Liquid Crystal Polymer)

In addition, in the present invention, a non-polyimide-based liquid crystal polymer may be incorporated as the additive into the material from the viewpoint of an improvement in liquid crystallinity. Examples of the liquid crystal polymer include such a main chain-type thermotropic liquid crystal polymer and side chain-type thermotropic liquid crystal polymer as described in Handbook of Liquid Crystals Vol. 3 (published by WILEY-VCH in 1998).

(Polymerizable Liquid Crystal Compound)

In addition, in the present invention, a liquid crystalline compound having a polymerizable functional group may be incorporated as the additive into the material from the viewpoint of, for example, an improvement in liquid crystallinity. Specific examples of such polymerizable liquid crystal compound are given below.

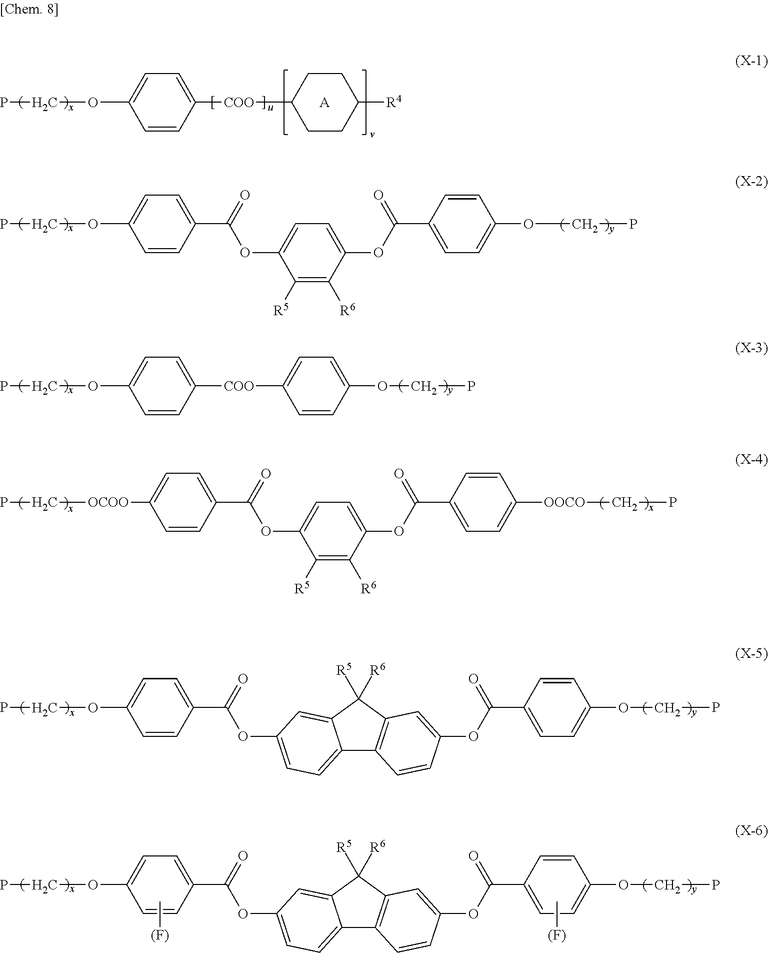

In the formulae, P represents a polymerizable functional group. In addition, in the formulae, R⁴'s each independently represent —F, —Cl, —CN, —NO₂, —OH, —OCH₃, —OCN, —SCN, —OCF₃, an alkyl having 1 to 12 carbon atoms which may be halogenated, an alkylcarbonyl whose alkyl has 1 to 12 carbon atoms, an alkoxycarbonyl whose alkoxy has 1 to 12 carbon atoms, an alkylcarbonyloxy whose alkyl has 1 to 12 carbon atoms, or an alkoxycarbonyloxy whose alkoxy has 1 to 12 carbon atoms. In addition, in the formulae, R⁵ and R⁶ each represent —H, —F, —Cl, —CN, or an alkyl having 1 to 7 carbon atoms which may be halogenated, an alkoxy having 1 to 7 carbon atoms, an alkylcarbonyl, an alkylcarbonyloxy whose alkyl has 1 to 7 carbon atoms, or an alkoxycarbonyloxy whose alkoxy has 1 to 7 carbon atoms. In addition, in the formulae, A represents 1,4-phenylene or 1,4-cyclohexylene which may be mono-, di-, or tri-substituted with R⁵. In addition, in the formulae, u represents 0 or 1, v represents 0, 1, or 2, and x and y each independently represent 1 to 12.

Preferred examples of the polymerizable functional group include the following structures.

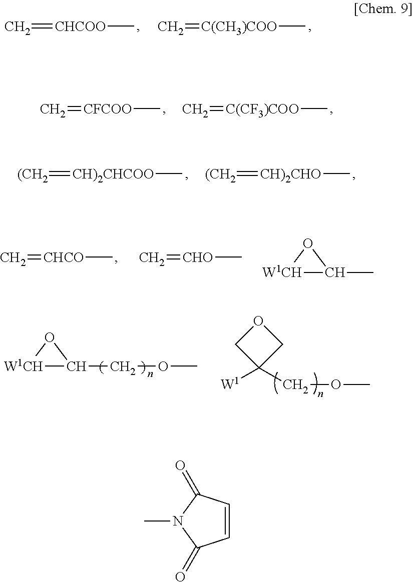

In the formulae, W¹ represents —H or an alkyl having 1 to 5 carbon atoms, and n represents 0 or 1.

(Crosslinking Agent)

In addition, in the present invention, a compound having two or more functional groups each of which reacts with a carboxylic acid residue of the polyamic acid, i.e., the so-called crosslinking agent may be further incorporated as the additive into the material from the viewpoint of the prevention of the deterioration of any characteristic over time or its deterioration due to an environment. Examples of such crosslinking agent include such a polyfunctional epoxy and isocyanate material as described in Japanese Patent No. 3049699, Japanese Patent Application Laid-open No. 2005-275360, and Japanese Patent Application Laid-open No. Hei 10-212484.

Such a crosslinking agent as described below can also be used for the same purpose as that described above. The crosslinking agent itself reacts to serve as a polymer having a network structure, thereby improving the strength of a polyamic acid or polyimide film. Examples of such crosslinking agent include such a polyfunctional vinyl ether, maleimide, and bisallyl nadimide derivative as described in Japanese Patent Application Laid-open Hei 10-310608 and Japanese Patent Application Laid-open No. 2004-341030.

The content of any such crosslinking agent is preferably less than 50 parts by weight, more preferably less than 30 parts by weight with respect to 100 parts by weight of the polyamic acid as the precursor of the liquid crystalline polyimide.

(Organosilicon Compound)

In addition, in the present invention, an organosilicon compound may be further incorporated as the additive into the material from the viewpoint of adjusting the adhesiveness to a glass substrate. Examples of the organosilicon compound include silane coupling agents such as aminopropyltrimethoxysilane, aminopropyltriethoxysilane, vinyltrimethoxysilane, N-(2-aminoethyl)-3-aminopropylmethyldimethoxysilane, N-(2-aminoethyl)-3-aminopropyltrimethoxysilane, vinyltriethoxysilane, 3-methacryloxypropyltrimethoxysilane, 3-glycidoxypropyltrimethoxysilane, 3-glycidoxypropylmethyldimethoxysilane, and 2-(3,4-epoxycyclohexyl)ethyltrimethoxysilane, and silicone oils such as dimethylpolysiloxane, polydimethylsiloxane, and polydiphenylsiloxane. The addition amount of the organosilicon compound is preferably 0.01 to 5 parts by weight, more preferably 0.1 to 3 parts by weight with respect to 100 parts by weight of the liquid crystalline polyimide or the precursor thereof.

(Other Additives)

In addition, in the present invention, various additives may each be further incorporated into the material as desired. For example, when an additional improvement in coating property is desired, a surfactant in accordance with such purpose may be incorporated in an appropriate amount into the material; when an additional improvement in antistatic performance is desired, an antistatic agent may be incorporated in an appropriate amount into the material; or when a polymerizable liquid crystal compound or a crosslinking agent is incorporated, a polymerization initiator may be incorporated in an appropriate amount into the material for accelerating the polymerization reaction of the compound or the crosslinking reaction of the agent.

Hereinafter, the material containing the liquid crystalline polyimide or the precursor thereof, and any such additive as described in the foregoing is referred to as “material for a retardation film.”

<Approach for Obtaining Retardation Film>

The material for a retardation film can be used in the form of being dissolved in a solvent having an ability to dissolve the material. Hereinafter, such form is referred to as “material solution for a retardation film.” Such solvent comprehends a wide variety of solvents typically used in the production or use of a polyamic acid or a derivative thereof, and can be appropriately selected depending on its intended use. Examples of such solvent are given below.

Examples of aprotic polar organic solvents which are good solvents for polyamic acid include lactones such as N-methyl-2-pyrrolidone (NMP), dimethylimidazolidinone, N-methylcaprolactam, N-methylpropionamide, N,N-dimethylacetamide, dimethylsulfoxide, N,N-dimethylformamide (DMF), N,N-diethylformamide, N,N-diethylacetamide (DMAc), and γ-butyrolactone (GBL).

Examples of solvents other than solvents described above, for the purpose of improving coating properties or the like includes alkyl lactates, 3-methyl-3-methoxybutanol, tetralin, isophorone, ethylene glycol monoalkyl ethers such as ethylene glycol monobutyl ether (BCS), diethylene glycol monoalkyl ethers such as diethylene glycol monoethyl ether, ethylene glycol monoalkyl acetate and ethylene glycol phenyl acetate, triethylene glycol monoalkyl ethers, propylene glycol monoalkyl ethers such as propylene glycol monobutyl ether, dialkyl malonates such as diethyl malonate, dipropylene glycol monoalkyl ethers such as dipropylene glycol monomethyl ether, and ester compounds of these glycol monoethers or the like. Of those, NMP, dimethylimidazolidinone, GBL, BCS, diethylene glycol monoethyl ether, propylene glycol monobutyl ether, dipropylene glycol monomethyl ether, and the like can be particularly preferably used as the solvent.

The solvent in the material solution for a retardation film has only to be incorporated so that the concentration of solid matter in the material solution for a retardation film may be a proper value in accordance with any one of the following various application methods. In ordinary cases, the content of the solvent in the material solution for a retardation film is preferably such an amount that the concentration of the solid matter in the material solution for a retardation film is 0.1 to 30 wt % from the viewpoint of the suppression of unevenness, a pinhole, or the like at the time of coating. The content is more preferably such an amount that the concentration is 1 to 20 wt %.

The retardation film of the present invention is obtained by: irradiating a coating film, which is obtained by applying the above-mentioned material solution for a retardation film to a substrate, with light in an arbitrary polarization state to impart anisotropy to the alignment of a photoreactive group of a polyamic acid having the photoreactive group; heating the coating film to the liquid crystal temperature range of the coating film after the irradiation to form (bake) a film of the liquid crystalline polyimide through the dehydration of the polyamic acid; and expressing and enhancing the optical anisotropy of the formed film.

In this case, the retardation film of the present invention is preferably produced by the following procedure from the viewpoint of the expression of sufficient optical anisotropy:

(1) the material solution for a retardation film is applied onto the substrate by, for example, a brush coating method, an immersion method, a spinner method, a spray method, a printing method, or an inkjet method;
(2) the coating film formed on the substrate is heated at 50 to 120° C., preferably 80 to 100° C. so that the solvent may be evaporated;
(3) the coating film is irradiated with the light in an arbitrary polarization state so that the polyamic acid in the coating film may be aligned; and
(4) the coating film in which the polyamic acid has been aligned is heated at 150 to 300° C., preferably 180 to 250° C. so as to be imidated and to be caused to express a liquid crystal phase.

When a retardation film whose optical axis is horizontal to the substrate is produced, linearly polarized light is suitably used for the alignment of the polyamic acid. For example, when the photoreactive group is azobenzene, the long axis of the molecular structure of azobenzene is aligned by irradiation with the linearly polarized light in a direction vertical to the polarization direction. The linearly polarized light is not particularly limited as long as the light can align the polyamic acid in the coating film. In the coating film, the polyamic acid can be aligned by low-energy photoirradiation. In view of the foregoing, the dose of the linearly polarized light in an optical alignment treatment for the polyamic acid is preferably less than 10 J/cm². In addition, the linearly polarized light preferably has a wavelength of 300 to 400 nm. It should be noted that a retardation film whose optical axis is horizontal to the substrate is obtained via the same mechanism under the same production conditions with a polyamic acid obtained from the diamine compound having a photoreactive group (I-1), (I-2), (I-3), (II-1), (II-2), (II-3), (III-1), (IV-1), (IV-2), (IV-3), (V-1), (VI-1), (VI-2), (VI-3), (VI-4), (VI-5), or (VI-6), or from the acid anhydride (IV-4) or (VI-8) as well.

Such production steps are substantially the same as production steps for a conventional optical alignment film based on an aligning agent. Although the conventional optical alignment film based on the aligning agent has a function as an alignment film of aligning a liquid crystalline material typified by a polymerizable liquid crystal material, the film hardly obtains characteristics as a retardation film such as a retardation in a sufficient fashion. In contrast, the liquid crystalline polyimide containing a photoreactive group largely differs from the conventional aligning agent in the following point. When the polyimide itself is aligned, sufficient characteristics as a retardation film as well as a function as an alignment film as in the conventional optical alignment film are obtained.

<Approach for Obtaining Retardation Film in which One or Both of Characteristics, i.e., Optical Axis and Retardation is or are Patterned>

An approach to patterning an optical axis or a retardation in a specific region is described. The following three approaches are specifically given.

(1) Light in an arbitrary polarization state that differs for each predetermined region is applied.

The arbitrary polarization state is a specific polarization state selected from linearly polarized light, circularly polarized light, elliptically polarized light, and unpolarized light. When the coating film of the polyamic acid is irradiated with light in a predetermined polarization state, the direction of the optical axis or the magnitude of the retardation in the retardation film is controlled. A patterned retardation film in which the direction of the optical axis or the magnitude of the retardation differs for each predetermined region is obtained by: irradiating the film of the polyamic acid before its imidation by heating with light beams in different arbitrary polarization states a plurality of times together with a masking technology such as a photomask; and performing the imidation and heating to the temperature at which the film expresses a liquid crystal phase in one stroke after the irradiation.

(2) Light in an arbitrary polarization state is applied at an illuminance or irradiation energy intensity which differs for each predetermined region.

The magnitude of the retardation in the retardation film is controlled by irradiating the coating film of the polyamic acid with light in an arbitrary polarization state at different illuminances or different irradiation energy intensities. A patterned retardation film in which the magnitude of a retardation differs for each predetermined region is obtained by: irradiating the film of the polyamic acid before its imidation by heating with light in an arbitrary polarization state while changing its illuminance or irradiation energy intensity together with a masking technology such as a photomask; and performing the imidation and heating to the temperature at which the film expresses a liquid crystal phase in one stroke after the irradiation.

(3) A retardation film whose thickness differs for each predetermined region is formed.

The magnitude of the retardation in the retardation film is controlled by changing the thickness of the coating film of the polyamic acid. The thickness of each region of the coating film can be changed by forming the coating film by a method such as an inkjet method by which material solutions for a retardation film (differing from each other in, for example, concentration, viscosity, or composition) can be selectively applied to specific regions in the same film.

The retardation film in the present invention in which one or both of the optical characteristics, i.e., the optical axis and the retardation is or are patterned is obtained by employing any one of those approaches alone or by arbitrarily combining two or more thereof.

<Retardation Film Formed of Material Except Liquid Crystalline Polyimide Containing Photoreactive Group>

An optical device of the present invention has the retardation film of the present invention described in the foregoing. The optical device in the present invention has only to have at least one layer of the retardation film of the present invention described in the foregoing, and may have a plurality of layers of the retardation films of the present invention, or may include a retardation film formed of a material except the liquid crystalline polyimide containing a photoreactive group as well as the retardation film formed of the liquid crystalline polyimide containing a photoreactive group. In addition, the kind of the retardation film of the present invention which the optical device of the present invention has is not particularly limited.

First, definitions concerning the retardation film of the present invention are described.

(Refractive Indices in Three Axial Directions of Retardation Film)

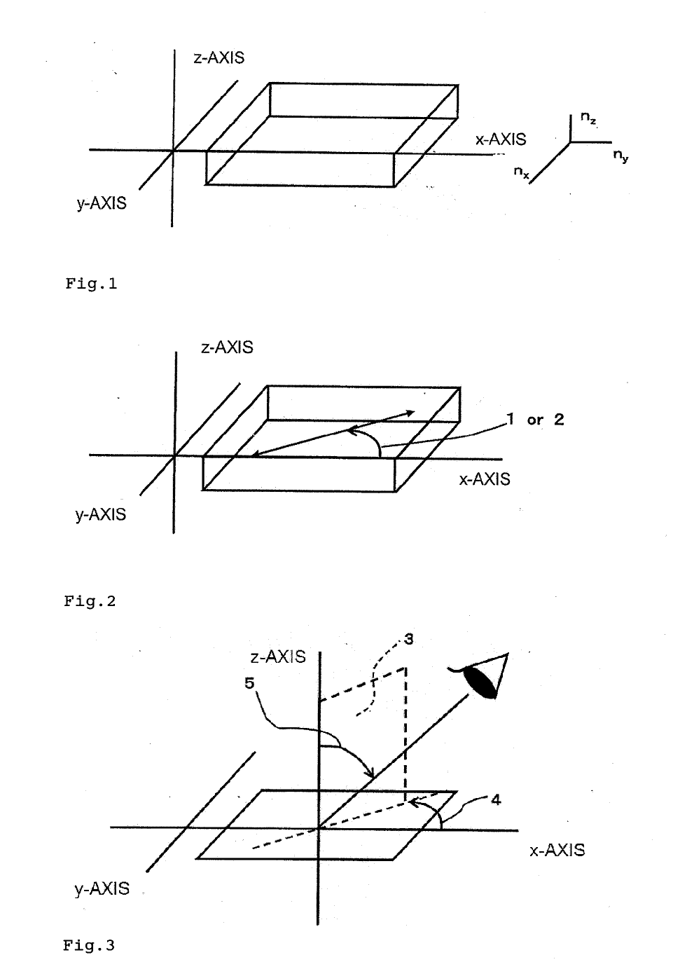

First, the anisotropy of the refractive index of the retardation film is described with an orthogonal coordinate system with reference to FIG. 1. When axes parallel to the plane of the retardation film and perpendicular to each other are defined as an x-axis and a y-axis, and an axis vertical to the surface of the retardation film is defined as a z-axis, the refractive index of the retardation film can be resolved into directions parallel to the respective axes. Refractive indices as a result of the resolution corresponding to the respective x, y, and z-axes are represented by nx, ny, and nz, respectively, and the thickness of the retardation film is represented by d. In the description, nx is defined as being larger than ny when nx is not equal to ny. In this case, a retardation (Re) in the plane direction of the retardation film is represented by (nx−ny)×d, and a retardation (Rth) in the direction vertical to the plane of the retardation film is represented by [{(nx+ny)/2}−nz]×d. In addition, the birefringence of the retardation film is represented by nx−ny(=Δn).

(Axial Angles of Retardation Film and Polarizing Plate)

Next, the axial angles of the optical axis of the retardation film and the absorption axis of a polarizing plate are defined. An X-axis and a Y-axis correspond to the axes of the XY plane as a plane parallel to the film plane of the retardation film or of the polarizing plate, and an axis parallel to the normal line of the film plane of the retardation film or of the polarizing plate is a Z-axis. In the case where the retardation film is an A-plate to be described later, its optical axis corresponds to the x-axis when the A-plate is a positive A-plate, or corresponds to the y-axis when the A-plate is a negative A-plate. As illustrated in FIG. 2, when the optical axis is not parallel to the X-axis, an axial angle 1 of the optical axis is represented as an angle formed between the optical axis and the X-axis, and is displayed so as to increase positively counterclockwise. In addition, in the case where the retardation film is a C-plate to be described later, the z-axis as its optical axis is parallel to the Z-axis. An axial angle 2 of the absorption axis of the polarizing plate is represented as an angle formed between the absorption axis of the polarizing plate and the X-axis, and is displayed so as to increase positively counterclockwise.

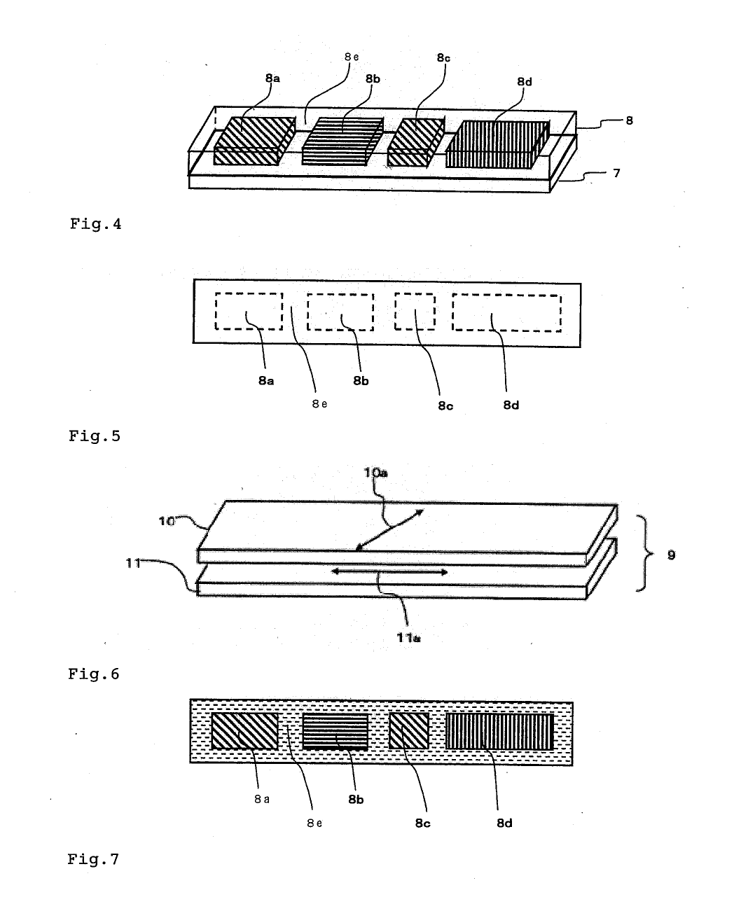

Further, in the observation of the retardation film, the optical device, or a liquid crystal display apparatus, as illustrated in FIG. 3, a plane including the observation direction of an observer (orientation of his or her line of sight) and the Z-axis is referred to as “incidence plane 3,” an angle formed between the X-axis and the incidence plane 3 is referred to as “azimuth angle 4,” and an angle formed between the observation direction of the observer and the Z-axis in the incidence plane 3 is referred to as “polar angle 5.” The azimuth angle 4 is displayed so as to increase positively counterclockwise with respect to a reference orientation (such as the orientation of the optical axis of the retardation film). The polar angle 5 is displayed so as to increase positively clockwise from the Z-axis.

Retardation films are classified depending on a difference in magnitude correlation among the respective refractive indices nx, ny, and nz in the three axial directions illustrated in FIG. 1.

(1) Positive A-Plate

The positive A-plate has a relationship of nx>ny=nz among the refractive indices in the three axial directions. The plate shows positive uniaxiality, and may be represented as a retardation film whose optical axis is parallel to the thin-film surface of the retardation film. The plate is obtained by stretching a transparent resin whose intrinsic birefringence ratio is positive such as a cyclic olefin-based resin or a modified polycarbonate resin under a specific condition. Alternatively, the plate is obtained by forming and immobilizing, on a transparent substrate, homogeneous alignment in which the directors of a liquid crystalline material having a rod-shaped mesogen skeleton are uniform. An example of the horizontal alignment of a polymerizable liquid crystal material having a rod-shaped mesogen skeleton is described in Japanese Patent Application Laid-open No. 2006-307150 or the like.

(2) Negative C-Plate

The negative C-plate has a relationship of nx=ny>nz among the refractive indices in the three axial directions. The plate shows negative uniaxiality, and may be represented as a retardation film whose optical axis coincides with the normal direction of the thin-film surface of the retardation film. The plate is obtained by stretching a transparent resin whose intrinsic birefringence ratio is positive such as a cyclic olefin-based resin, a polycarbonate resin, a cellulose-based resin, an acrylic resin, a polyamideimide-based resin, a polyether ether ketone-based resin, or a polyimide-based resin under a specific condition. Alternatively, when the thin film is molded by a solvent casting method, the plate is obtained by spontaneous alignment of molecules in the evaporation process of the solvent. In addition, the plate is obtained by immobilizing, on a transparent substrate, specific alignment of a liquid crystalline material having a mesogen skeleton of a specific shape as well. One type of such plate is obtained by the spiral alignment of a liquid crystalline material having a rod-shaped mesogen skeleton. In this case, it is postulated that a spiral axis is parallel to the normal direction of the surface of the transparent substrate and that a spiral pitch is less than 300 nm. An example of the spiral alignment of a polymerizable liquid crystal material having a rod-shaped mesogen skeleton is described in Japanese Patent Application Laid-open No. 2005-263778 or the like. Another type of such plate is obtained by immobilizing the homeotropic alignment of a disk-shaped mesogen skeleton. Alternatively, the plate is obtained by causing a liquid crystalline material having a rod-shaped mesogen skeleton to permeate a transparent resin to form homogeneous alignment having random directors.

(3) Positive C-Plate

The positive C-plate has a relationship of nx=ny<nz among the refractive indices in the three axial directions. The plate shows positive uniaxiality, and may be represented as a retardation film whose optical axis coincides with the normal direction of the thin-film surface of the retardation film. The plate is obtained by stretching a resin whose intrinsic birefringence ratio is negative such as a polystyrene-based resin or an N-substituted maleimide copolymer under a specific condition. Alternatively, the plate is obtained by forming and immobilizing, on a transparent substrate, the homeotropic alignment of a liquid crystalline material having a rod-shaped mesogen skeleton. An example of the homeotropic alignment of a polymerizable liquid crystal material having a rod-shaped mesogen skeleton is described in Japanese Patent Application Laid-open No. 2006-188662 or the like.

(4) Negative A-Plate

The negative A-plate has a relationship of nz=nx>ny among the refractive indices in the three axial directions. The plate shows negative uniaxiality, and may be represented as a retardation film whose optical axis is parallel to the thin-film surface of the retardation film. The plate is obtained by stretching a transparent resin whose intrinsic birefringence ratio is negative such as a polystyrene-based resin or an N-substituted maleimide copolymer under a specific condition. Alternatively, the plate is obtained by forming and immobilizing, on a transparent substrate, homogeneous alignment in which the directors of a liquid crystalline material having a disk-shaped mesogen skeleton are uniform. In addition, it has been reported that the plate is obtained on the basis of the shape of supramolecular packing by disk-shaped molecules or rectangular molecules to be expressed in a lyotropic phase and its alignment mode.

(5) Biaxial Plate (I)

The biaxial plate (I) has a relationship of nx>ny>nz among the refractive indices in the three axial directions. The plate is obtained by stretching a resin whose intrinsic birefringence ratio is positive such as a cyclic olefin-based resin, a polycarbonate resin, a cellulose-based resin, an acrylic resin, a polyamideimide-based resin, a polyether ether ketone-based resin, or a polyimide-based resin under a specific condition. Alternatively, the plate is obtained by further stretching the negative C-plate obtained from a transparent resin described above. In addition, the plate is obtained by immobilizing a liquid crystalline material having a rod-shaped mesogen skeleton, the material being subjected to such spiral alignment that a spiral pitch periodically changes in a spiral axis direction. More specifically, the plate is obtained by: forming, with a polymerizable cholesteric liquid crystal material containing a dichroic polymerization initiator, such alignment that the spiral axis is parallel to the normal direction of the surface of a transparent substrate and the spiral pitch is less than 300 nm; and irradiating the alignment with polarized ultraviolet light. This is probably because of the following reason. A periodic concentration gradient is provided for the generation of a free radical in the spiral axis direction because the free radical is more easily generated as the extent to which the polarization direction of the ultraviolet light and a director of the dichroic polymerization initiator are parallel to each other enlarges. An example of the plate is described in Japanese Patent Translation Publication No. 2005-513241 or the like.

(6) Biaxial Plate (II)

The biaxial plate (II) has a relationship of nx>nz>ny among the refractive indices in the three axial directions. The plate is obtained by stretching a cyclic olefin-based resin or the like under a special condition. The plate is described in Japanese Patent Application Laid-open No. 2006-72309 or the like. In addition, it has been reported that the plate is obtained on the basis of the shape of supramolecular packing by rectangular molecules to be expressed in a lyotropic phase and its alignment mode.

(7) Biaxial Plate (III)

The biaxial plate (III) has a relationship of nz>nx>ny among the refractive indices in the three axial directions. The plate is obtained by stretching the above-mentioned transparent resin whose intrinsic birefringence ratio is negative under a specific condition.

Further, examples of the retardation films that cannot be classified depending on a difference in magnitude correlation among the refractive indices nx, ny, and nz in the three axial directions are given.

(8) Retardation Film Obtained from Tilt-Aligned Liquid Crystalline Material

The retardation film is a retardation film obtained by immobilizing a liquid crystalline material having a rod-shaped or disk-shaped mesogen skeleton on a transparent substrate in which directors are tilted between directions horizontal and vertical to the plane of the substrate. When the tilt angles from the interface of the substrate to an air interface are constant, such alignment is referred to as “spray alignment,” and when the tilt angles continuously change, such alignment is referred to as “hybrid alignment.” An example of the tilt alignment of a polymerizable liquid crystal material having a rod-shaped mesogen skeleton is described in Japanese Patent Application Laid-open No. 2006-307150 or the like.

Given next is an example in which a film obtained by immobilizing a cholesteric liquid crystalline material having a rod-shaped mesogen skeleton on a substrate expresses a function as a specific retardation film by virtue of a relationship between a wavelength of interest and a spiral pitch when a spiral axis in the film is parallel to the normal direction of the surface of the substrate.

(9) Retardation Film (I) Obtained from Spirally Aligned Liquid Crystalline Material Selective Reflective Film

When the wavelength of interest and the spiral pitch are of the same order, irradiating the film with light results in the reflection of only one of left-handed circularly polarized light and right-handed circularly polarized light corresponding to the left and right orientations of distortion out of the components of the light including a wavelength corresponding to the product of the spiral pitch and the average refractive index of the cholesteric liquid crystalline material.

(10) Retardation Film (II) Obtained from Spirally Aligned Liquid Crystalline Material Rotator

When the spiral pitch is longer than the wavelength of interest, the film expresses a function as a rotator. An example of the spiral alignment of a polymerizable liquid crystal material having a rod-shaped mesogen skeleton is described in Japanese Patent Application Laid-open No. 2005-171235 or the like.

In the present invention, the retardation film of any such kind can be produced depending on various conditions such as the kind of the liquid crystalline polyimide or the precursor thereof, the kind of the additive, and a polarization state and an irradiation direction in photoirradiation. For example, in the present invention, the positive A-plate described in the foregoing can be formed by: irradiating a coating film formed by using the polyamic acid containing a photoreactive group described in the foregoing with linearly polarized light from such a direction that a light beam direction coincides with the normal direction of a thin-film surface; and baking the resultant at 150 to 300° C.

Conventionally known retardation films may be used as the various retardation films described in the foregoing, and the various retardation films described in the foregoing can each be installed at an arbitrary position in the optical device of the present invention. Such optical device of the present invention having the retardation film of the present invention and a conventional retardation film is, for example, an optical device having: a patterned retardation film in which a pattern formed of at least two regions different from each other in one or both of the orientation of an optical axis and a retardation is formed; and a non-patterned retardation film in which the orientation of an optical axis and a retardation are uniform, in which the patterned retardation film is the retardation film of the present invention described in the foregoing and the non-patterned retardation film is the known retardation film.

Although a retardation film selected from the known retardation films described in the foregoing can be arbitrarily utilized as the non-patterned retardation film, the non-patterned retardation film is preferably a retardation film based on a polymerizable liquid crystal material in which the alignment state of a liquid crystal compound having a polymerizable functional group is immobilized by the crosslinking or polymerization of the liquid crystal compound from the viewpoints of the performance and production of the optical device, specifically because the film can be thinned, because a stretching treatment for causing the film to express optical anisotropy is not needed, and because the film is excellent in heat resistance. In the polymerizable liquid crystal material, the number of kinds of the liquid crystal compounds may be one, or may be two or more. One layer of such non-patterned retardation film may be used in the optical device of the present invention, or two or more layers of such non-patterned retardation films may be used therein. Examples of the polymerizable liquid crystal material include materials described in Japanese Patent Application Laid-open No. 2006-307150 and Japanese Patent Application Laid-open No. 2005-263778.

The polymerizable liquid crystal layer of the non-patterned retardation film can be a liquid crystal layer of any one of various forms by adopting a proper liquid crystal compound. Examples of the alignment state of the liquid crystal in such liquid crystal layer include horizontal alignment, spray alignment or hybrid alignment, vertical alignment, and spirally distorted alignment.

Although the retardation film of the present invention and the non-patterned retardation film may directly contact each other, or may be placed with any other layer interposed therebetween, it is preferred that the non-patterned retardation film be directly formed on the retardation film of the present invention as the patterned retardation film from the viewpoints of: the control of the alignment of the polyamic acid in the retardation film of the present invention or of the alignment of the liquid crystal compound in the non-patterned retardation film by a surface treatment for the retardation film of the present invention; and the expression or improvements of various optical characteristics in the optical device of the present invention.

For example, when a retardation film based on a liquid crystalline material is formed on the retardation film of the liquid crystalline polyimide containing a photoreactive group, the retardation film of the liquid crystalline polyimide containing the photoreactive group can be caused to function as an alignment film for the liquid crystalline material as well.

For example, when the photoreactive group is azobenzene, the long axis of a liquid crystal molecule in the liquid crystalline material is aligned in the long axis direction of azobenzene. In addition, as described in Japanese Patent Application Laid-open No. 2009-69493, the pretilt angle of the liquid crystal molecule can be controlled by: blending the material with a polyamic acid having a diamine having a specific structure; and irradiating the mixture with polarized ultraviolet light under a specific condition.

Further, the following is also useful for the purpose of adjusting the alignment of the liquid crystalline material. The surface of the retardation film based on the liquid crystalline polyimide containing the photoreactive group is subjected to a rubbing treatment, or is irradiated with an electromagnetic wave such as ultraviolet light having a specific energy intensity. The rubbing treatment induces the rearrangement of the polyimide main chain in the outermost surface of the retardation film toward an arbitrary direction. In addition, irradiation with ultraviolet light having a short wavelength has been known to exert such an effect as described below. The surface energy is increased and the pretilt angle of a liquid crystal molecule is reduced.

It should be noted that when a surface treatment such as the rubbing treatment or the ultraviolet irradiation described in the foregoing is performed in the retardation film of the present invention in a laminated optical device of the retardation film of the present invention and the non-patterned retardation film, the thickness of the retardation film of the present invention is preferably 5 nm or more, more preferably 10 nm or more, still more preferably 30 nm or more from such a viewpoint that both of the following characteristics are sufficiently obtained: an optical characteristic based on the alignment of the liquid crystalline polyimide in the retardation film of the present invention and an alignment characteristic for the liquid crystal compound of the upper layer in the surface of the retardation film of the present invention based on the surface treatment. However, the thickness of the retardation film of the present invention is set to a thickness sufficiently large (for example, 50 nm or more) as compared with the thickness needed for the surface treatment in some cases from the viewpoint of the expression of a desired optical characteristic. In the retardation film having such large thickness, there is no need to secure a thickness for such surface treatment because an influence of the surface treatment on an optical characteristic of the retardation film of the present invention is extremely small.

<Specific Optical Devices>

An optical device into which the patterned retardation film formed of the liquid crystalline polyimide having a photoreactive group is incorporated is described.

(Anti-Counterfeit Device)

An example in which the patterned retardation film formed of the liquid crystalline polyimide containing a photoreactive group is utilized as an anti-counterfeit device is described with reference to FIG. 4 by taking a reflective anti-counterfeit device, which utilizes the reflection of ambient light as light with which the anti-counterfeit device is observed, as an example. An anti-counterfeit device illustrated in FIG. 4 is constructed of a reflective substrate 7 and a retardation film 8 provided for the surface of the reflective surface of the reflective substrate 7.

A substrate obtained by coating the surface of a substrate such as a glass substrate with a metal oxide or a metal thin film having high reflective power can be used as the reflective substrate 7. Alternatively, a metal material that reflects light such as a metal foil can be directly used as the substrate.

The retardation film 8 is the retardation film of the liquid crystalline polyimide having a photoreactive group, the film being formed on the reflective substrate 7. Regions 8a to 8e each having a specific optical characteristic are formed in the retardation film 8. The regions 8a and 8c are identical to each other in optical characteristic, and the regions 8a, 8b, 8d, and 8e are different from one another in optical characteristic. The optical characteristics in the respective regions 8a to 8e are expressed by differences in orientation of an optical axis and in magnitude of the retardation Re. Such pattern in the retardation film 8 that the axial angle of the optical axis or the magnitude of the retardation differs for each predetermined region is obtained by: irradiating the film in the state of a polyamic acid with light whose polarization state, illuminance, or irradiation energy intensity differs for each predetermined region a plurality of times together with a masking technology such as a photomask; and performing imidation and heating to the temperature at which the film expresses a liquid crystal phase in one stroke after the irradiation. The region 8e is a region irradiated with no polarized ultraviolet light, and hence the magnitude of its retardation is zero.

When the anti-counterfeit device is observed while being irradiated with natural light as ambient light, reflected light is transformed into different polarization states depending on the direction of the optical axis, or the magnitude of the retardation, of the retardation film 8. However, the quantity of the light is constant and a human eye cannot recognize the difference in polarization state. Accordingly, the regions 8a to 8e are identical to one another in brightness and tinge. In addition, the thin film of the liquid crystalline polyimide is nearly colorless and transparent. Accordingly, as illustrated in FIG. 5, the color of the reflective substrate 7 based on the reflected light is uniformly observed as in reflection by the reflective substrate 7 alone.

Described next is the case where a polarizing filter 9 is installed on the anti-counterfeit device so that its absorption axis may have an arbitrary axial angle as illustrated in FIG. 6, and the device is observed while being irradiated with natural light as ambient light. The polarizing filter 9 is constructed of, for example, a polarizing plate 10 and a retardation film 11 formed on the polarizing plate 10, and is constructed so that the orientation (10a) of the absorption axis of the polarizing plate 10 may be 45° with respect to the orientation (11a) of the optical axis of the retardation film 11. The retardation film 11 is a non-patterned retardation film whose optical characteristics are uniform, and can be arbitrarily selected from the known retardation films.

The natural light passes the polarizing plate 10 and the retardation film 11, passes the retardation film 8, is reflected at the reflective substrate 7 to pass the retardation film 8 again, and passes the retardation film 11 and the polarizing plate 10 again to reach an observer 12. The natural light is transformed into elliptically polarized light by the polarizing filter 9, and is then incident on the retardation film 8. Upon passing of the retardation film 8 in which the regions 8a to 8e different from one another in orientation of an optical axis or in magnitude of a retardation are formed, the linearly polarized light is transformed into other polarization states different from each other from wavelength to wavelength depending on the orientations of the optical axes and the magnitudes of the retardations in the regions 8a to 8e in the retardation film 8. When the light beams in the transformed polarization states pass the polarizing filter 9 again, the light beams differ from each other in quantity of light capable of passing the filter depending on the polarization states for their respective wavelengths. Accordingly, as illustrated in FIG. 7, the observer 12 can recognize the differences of the patterned retardation film in axial angle of an optical axis and in magnitude of a retardation as differences in brightness and tinge.

As described above, the observer 12 can recognize the differences of the patterned retardation film in axial angle of an optical axis and in magnitude of a retardation as differences in brightness and tinge by observation through a filter that transforms light into a specific polarization state like the polarizing filter 9 or a filter that selectively causes light in a specific polarization state to pass. The filter that transforms light into a specific polarization state such as the polarizing filter 9 or the filter that selectively causes light in a specific polarization state to pass is referred to as “special filter” in the present invention. In the special filter, one polarizing plate 10 of FIG. 6 is a construction minimally required for the special filter, and the retardation film 11 of FIG. 6 is a construction that can be arbitrarily provided. The special filter free of the retardation film 11 and formed only of the polarizing plate 10 transforms light that has passed the filter into linearly polarized light, and the special film having the polarizing plate 10 and the retardation film 11 transforms light that has passed the filter into elliptically polarized light as described in the foregoing. The construction of the special filter, the magnitude of the retardation of the retardation film 11 to be applied, and the like can be determined depending on a desired polarization state.

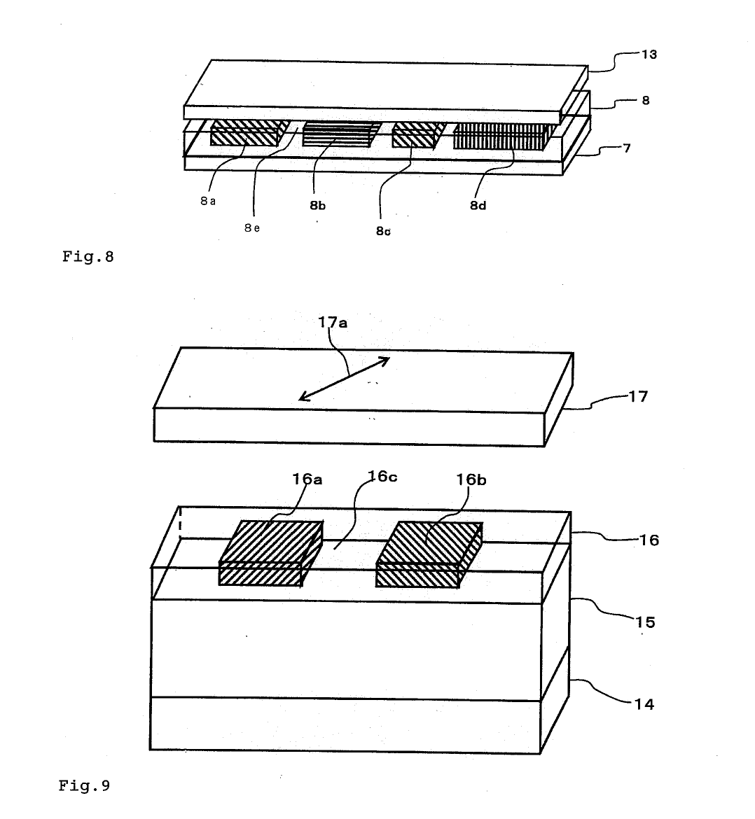

As illustrated in FIG. 8, one or more layers of retardation films 13 in each of which neither an optical axis nor a retardation is patterned can be added to the anti-counterfeit device for the purpose of, for example, adjusting a change in brightness or tinge upon observation through the special filter or additionally pointing up the change. Any such non-patterned retardation film 13, which is formed on the reflective substrate 7, can be provided at an arbitrary position on the side of the reflective substrate 7 or the observer 12 with the patterned retardation film 8 interposed therebetween.

When the non-patterned retardation film 13 is formed with a liquid crystalline material on the patterned retardation film 8 so as to be adjacent thereto, the retardation film 8 can be caused to serve as an alignment film for the liquid crystalline material as well. In this case, it is also useful to subject the surface of the retardation film 8 based on the liquid crystalline polyimide containing a photoreactive group to a rubbing treatment or ultraviolet irradiation for readjusting an anchoring energy on the liquid crystalline material. As described above, in this embodiment, a film that brings together an optical function called a retardation film and a function of aligning a liquid crystalline material can be obtained by substantially the same production steps as those in the case where an alignment film is provided by using a conventional aligning agent. Examples of the liquid crystalline material for forming the retardation film 13 include a polymerizable liquid crystal material, a liquid crystal polymer, and a lyotropic liquid crystal.

In the special filter, at least one retardation plate 11 having an arbitrary optical characteristic such as the axial angle of an optical axis or a retardation can be added to one polarizing plate 10 for the purpose of, for example, adjusting a change in brightness or tinge or additionally pointing up the change. The retardation plate 11 expresses an intrinsic function such as the transformation of a polarization state when the plate is positioned on the side opposite to the observer 10 with the polarizing plate 10 interposed therebetween at the time of the observation. When the observer performs the observation by attaching the retardation plates 11 to both sides of the polarizing plate 10 so that their optical characteristics such as a retardation may be different from each other for the purpose of complicating the change in brightness or tinge to be observed through the special filter, it is also useful to observe a difference in the change in brightness or tinge by changing the front and rear surfaces of the special filter, that is, by changing an optical characteristic of the retardation plate 11 placed on the side opposite to the side of the observer.

The retardation film of the present invention, which can be used as any one of the retardation films 8, 11, and 13, can be particularly suitably used as the retardation film 8 because an optical characteristic thereof can be partially changed by irradiation with polarized ultraviolet light through a mask corresponding to a specific pattern. The use of the retardation film of the present invention as the retardation film 8 can eliminate a step for forming an alignment film for aligning a liquid crystalline material in the steps of producing the retardation film 8 as compared with the case where a conventional retardation film formed of a liquid crystal alignment film and a liquid crystalline material is used as the retardation film 8. In addition, the use enables easy formation of the regions 8a to 8e. Further, the use enables easy formation of a high-definition image by the regions 8a to 8e. In addition, when the retardation film 11 is formed on the retardation film 8 by a step involving baking, the retardation film of the present invention can suppress a change in an optical characteristic of the retardation film 8 due to the baking because of its excellent heat resistance.

Next, an example in which an optical device obtained by combining a patterned retardation film formed of a liquid crystalline polyimide containing a photoreactive group and a selective reflective film is used as an anti-counterfeit device is described with reference to FIG. 9.

An anti-counterfeit device of FIG. 9 is constructed of a substrate 14, a selective reflective film 15 formed on the substrate 14, and a retardation film 16 placed on the selective reflective film 15.

The substrate 14 is a substrate that absorbs light in a specific wavelength range, and a substrate formed of a resin kneaded with a pigment or the like which absorbs light in the specific wavelength range, or a substrate obtained by attaching a thin film of a resin kneaded with a pigment or the like which absorbs light in the specific wavelength range to a transparent substrate can be used as the substrate 14.

The selective reflective film 15 reflects one of right-handed circularly polarized light and left-handed circularly polarized light (left-handed circularly polarized light in FIG. 9) in a specific wavelength band (ideally including a specific wavelength λ). The selective reflective film 15 is formed with, for example, a material and a production method described in Japanese Patent Application Laid-open No. 2005-171235.

The retardation film 16 is a retardation film formed of a liquid crystalline polyimide containing a photoreactive group, and is a patterned retardation film. That is, two regions 16a and 16b different from each other in optical characteristic, and a region 16c surrounding these regions and further different from these regions in optical characteristic are formed in the retardation film 16 by the masking technology such as a photomask described in the foregoing, irradiation with linearly polarized light, and baking. For example, the regions 16a and 16b are each a region having a retardation of ¼λ, the region 16c is a region whose retardation is zero, and the optical axes of the respective regions 16a and 16b are oriented so as to be perpendicular to each other.

In addition, a special filter for observing the anti-counterfeit device of FIG. 9 is a polarizing plate 17.

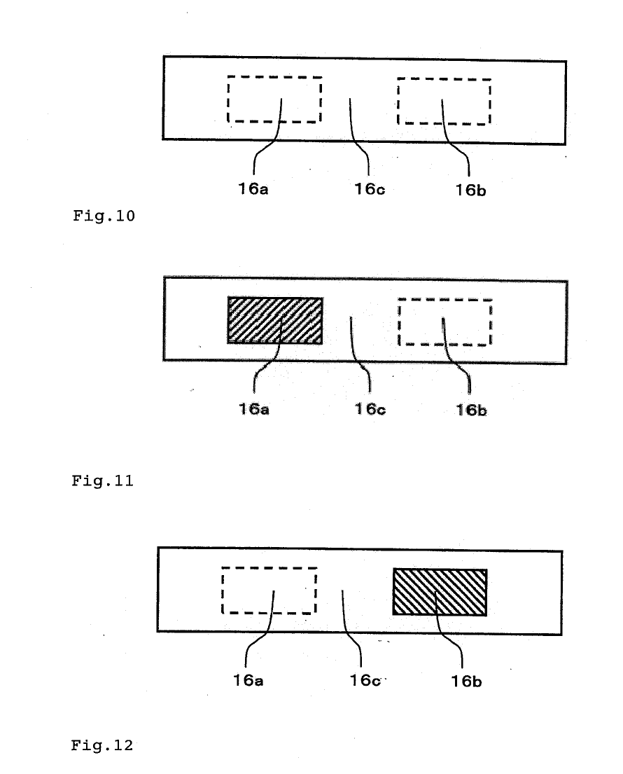

When the anti-counterfeit device of FIG. 9 is observed while being irradiated with natural light without through the polarizing plate 17, only left-handed circularly polarized light in the reflective wavelength band of the selective reflective film 15 out of the natural light is reflected irrespective of the magnitude of a retardation and the orientation of an optical axis that differ depending on the pattern of the retardation film 16. As illustrated in FIG. 10, the observer 12 recognizes uniform, specific brightness and a uniform, specific tinge based on selective reflection by the selective reflective film 15.

Described next is the case where the anti-counterfeit device of FIG. 9 is observed through the polarizing plate 17.

When natural light passes the polarizing plate, only a component in the direction of the transmission axis of the polarizing plate out of its components is selectively transmitted. The optical axis of linearly polarized light thus obtained is at ±45° with respect to the transmission axis of the polarizing plate, and when light having the specific wavelength λ passes a retardation film having a retardation of ¼λ, the light is transformed into left-handed circularly polarized light or right-handed circularly polarized light depending on whether the optical axis of the retardation film is at a positive angle or a negative angle. A product obtained by combining the polarizing plate and the ¼λ plate as described above is called a circularly polarizing plate because the product selectively transmits only one of the left- and right-handed circularly polarized light components for the specific wavelength λ of the natural light. Hereinafter, in the present application, a circularly polarizing plate that selectively transmits left-handed circularly polarized light is referred to as “left-handed circularly polarizing plate,” and a circularly polarizing plate that selectively transmits right-handed circularly polarized light is referred to as “right-handed circularly polarizing plate.”

A combination of the polarizing plate 17 and a region having a retardation of ¼λ in the patterned retardation film 16 can be the above-mentioned circularly polarizing plate. Here, the optical axes in the regions 16a and 16b are perpendicular to each other. Accordingly, in accordance with the orientation of the transmission axis of the special filter, that is, the polarizing plate, when a combination of the polarizing plate 17 and the region 16a is the left-handed circularly polarizing plate, a combination of the polarizing plate 17 and the region 16b is the right-handed circularly polarizing plate, and when the combination of the polarizing plate 17 and the region 16a is the right-handed circularly polarizing plate, the combination of the polarizing plate 17 and the region 16b is the left-handed circularly polarizing plate.

When the anti-counterfeit device of FIG. 9 is observed through the polarizing plate 17, the polarizing plate 17 is matched with the anti-counterfeit device so that its transmission axis may be at ±45° with respect to the optical axis of the retardation film in the region 16a or region 16b of the pattern of the retardation film.

When the combination of the polarizing plate 17 and the region 16a is the right-handed circularly polarizing plate, a region corresponding to the region 16a darkens as illustrated in FIG. 11 because the right-handed circularly polarized light having the specific wavelength λ is not reflected at the selective reflective film. At this time, the combination of the polarizing plate 17 and the region 16b is the left-handed circularly polarizing plate, and hence the left-handed circularly polarized light having the specific wavelength λ is reflected at the selective reflective film. As a result, a region corresponding to the region 16b does not darken.

In addition, when the combination of the polarizing plate 17 and the region 16b is the right-handed circularly polarizing plate, a region corresponding to the region 16b darkens as illustrated in FIG. 12 because the right-handed circularly polarized light having the specific wavelength λ is not reflected at the selective reflective film. At this time, the combination of the polarizing plate 17 and the region 16a is the left-handed circularly polarizing plate, and hence the left-handed circularly polarized light having the specific wavelength λ is reflected at the selective reflective film. As a result, a region corresponding to the region 16a does not darken.

In the anti-counterfeit device of FIG. 9, the alignment of the liquid crystalline polyimide containing a photoreactive group in the retardation film 16 is not affected by the alignment of a mesogen skeleton in the selective reflective film 15, and the orientation of the optical axis of each of the retardation films 16a and 16b in the state of a polyamic acid is controlled by a masking technology such as a photomask and the orientation of the polarization axis of linearly polarized light to be applied.

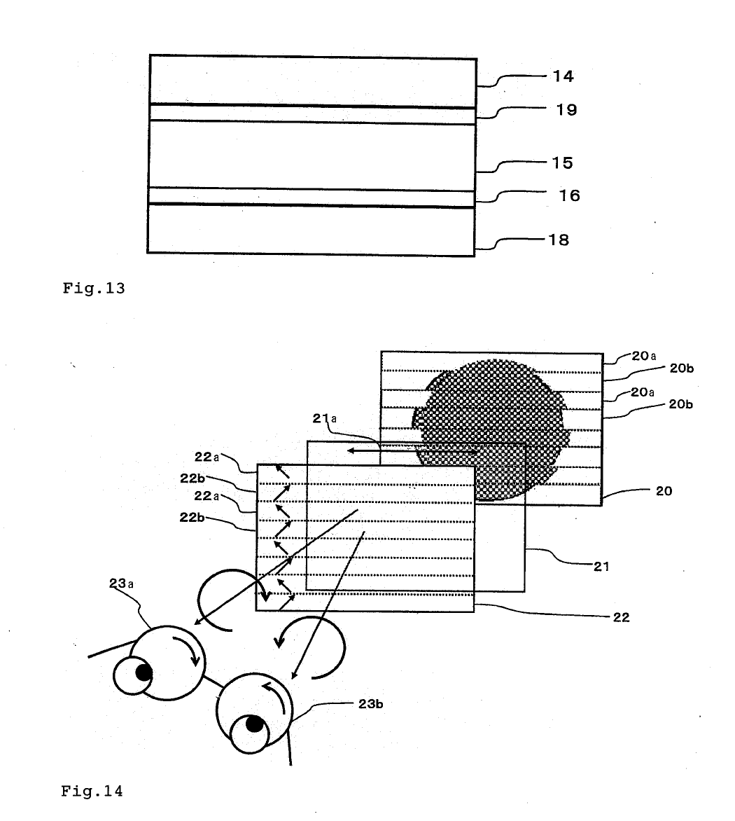

In addition, the anti-counterfeit device of FIG. 9 is obtained by the following as well. As illustrated in FIG. 13, the patterned retardation film 16 is formed on a support 18, the selective reflective film 15 is formed on the retardation film 16, a adhesive layer 19 is formed on the selective reflective film 15, the selective reflective film 15 and the substrate 14 are attached to each other through the adhesive layer 19, and finally the support 18 is peeled. In such case, the film of the liquid crystalline polyimide containing a photoreactive group corresponding to the patterned retardation film 12 can be caused to function as an alignment film for the liquid crystalline material of the selective reflective film 15 as well. Further, in this case, it is also useful to subject the surface of the patterned retardation film 16 based on the liquid crystalline polyimide containing a photoreactive group to a rubbing treatment or ultraviolet irradiation for readjusting an anchoring energy on the liquid crystalline material of the selective reflective film 15.

Further, any such anti-counterfeit device can be combined with an optical device based on a different principle such as a hologram. A specific approach to the combination is, for example, to add a hologram sheet to the optical device or to form an embossed hologram on the surface on the side of the substrate 14 of the selective reflective film 15 in the anti-counterfeit device of FIG. 9.

The anti-counterfeit device in each embodiment described in the foregoing can be regarded as being such that a difference in information about polarization is patterned. The difference in information about polarization is a latent image because the difference is indistinguishable to a human eye, and the latent image is recognized through a special filter such as a polarizing plate by replacing information about polarization with a difference in quantity of light that can be transmitted through the special filter. In addition, such difference in information about polarization cannot be copied by the copying function of an ordinary copying machine.

Therefore, when any such anti-counterfeit device is turned into a label together with an adhesive layer or a heat-sealing layer and the label is attached to any one of, for example, the premium tickets, marketable securities, certificates, tickets, cards or computer softwares, music softwares, and cases of brand-name goods, the label enables authentication and can be utilized as proof that the product to which the label is attached is not a counterfeit.

The retardation film of the present invention can be suitably used as the retardation film 16 in the anti-counterfeit device of FIG. 9, and as described in the foregoing, is superior to the case where a conventional retardation film is used from the viewpoints of labor savings upon production of such retardation film and easy, fine formation of the regions, and from the viewpoint of its excellent heat resistance. It should be noted that a region whose Re is zero can be formed by, for example, applying unpolarized light from a direction vertical to the surface of the coating film or applying no light.

<Display Apparatus>

A display apparatus of the present invention is an image display apparatus having a retardation film, and has the retardation film of the present invention described in the foregoing as part or the entirety of the retardation film. The display apparatus of the present invention can be constructed by adopting the retardation film of the present invention described in the foregoing as part or the entirety of a retardation film in the known image display apparatus. Hereinafter, a display apparatus into which the patterned retardation film formed of the liquid crystalline polyimide having a photoreactive group is incorporated is described.

(Stereo Image Display Apparatus)

A stereo image display apparatus into which the patterned retardation film formed of the liquid crystalline polyimide containing a photoreactive group is incorporated is described with reference to FIG. 14. A stereo image display apparatus of FIG. 14 is constructed of an image display apparatus 20, a polarizing plate 21 placed on the display surface of the image display apparatus 20, and a retardation film 22 placed on the polarizing plate 21.

The image display apparatus 20 is a display apparatus that displays a two-dimensional image. The image display apparatus 20 is an apparatus that displays an image in each of a plurality of regions as a result of division in a line direction, and is an apparatus that displays two kinds of images similar to an image to be displayed in accordance with the parallax of an observer in an odd-numbered line 20a and an even-numbered line 20b. A liquid crystal display, a plasma display, an organic EL display, or the like can be applied to the image display apparatus 20. When the image display apparatus 20 displays a stereo image, for example, an image for a left eye is displayed in the odd-numbered line 20a and an image for a right eye is displayed in the even-numbered line 20b.

The polarizing plate 21 is attached to the display surface of the image display apparatus 20. The polarizing plate 21 has a unidirectional absorption axis indicated by an arrow 21a.

The retardation film 22 is attached to the polarizing plate 21. The retardation film 22 is a film of a liquid crystalline polyimide having a photoreactive group, and is a patterned retardation film in which two kinds of regions 22a and 22b different from each other in at least one of the parameters, i.e., an optical axis and a retardation corresponding to the odd-numbered line 20a and the even-numbered line 20b are patterned as described below. Together with the polarizing plate 21, the film transforms image light for a left eye from the odd-numbered line 20a into a specific polarization state (right-handed circularly polarized light in FIG. 14), and transforms image light for a right eye from the even-numbered line 20b into another specific polarization state (left-handed circularly polarized light in FIG. 14) different from the above-mentioned polarization state. For example, as illustrated in FIG. 14, the retardation film 22 is patterned so that the regions 22a and 22b may each have the same retardation of ¼λ, but only their optical axes may be at −45° and +45°, respectively with respect to the absorption axis of the polarizing plate 21.

The image light for a left eye emitted from the odd-numbered line 20a of the image display apparatus 20 passes the polarizing plate 21, passes the region 22a of the retardation film 22, and is then transformed into right-handed circularly polarized light. The image light for a right eye emitted from the even-numbered line 20b of the image display apparatus 20 passes the polarizing plate 21, passes the region 22b of the retardation film 22, and is then transformed into left-handed circularly polarized light.

When the observer is mounted with a polarizing filter 23a that allows only the right-handed circularly polarized light to pass as a special filter for a left eye that covers the view of a left eye 24a of the observer and a polarizing filter 23b that allows only the left-handed circularly polarized light to pass as a special filter for a right eye that covers the view of a right eye 24b of the observer, the left eye 24a can capture only the image light for a left eye and the right eye 24b can capture only the image light for a right eye. As a result, the observer can recognize the stereo image.

When the image display apparatus 20 is a liquid crystal display, the polarizing plate 21 can be installed in the liquid crystal display together with a function of a polarizing plate to be originally provided on the observer side of the liquid crystal display.

Such a structure that a non-patterned retardation film as well as the patterned retardation film 22 formed of the liquid crystalline polyimide containing a photoreactive group is separately added (not shown) is also a preferred embodiment of the stereo image display apparatus. In this case, the non-patterned retardation film can be installed at an arbitrary position between the polarizing plate 21 and the polarizing filter 23a or 23b.

Although the left- or right-handed circularly polarized light has been given as a specific polarization state in FIG. 14, the application of a combination of linearly polarized light beams the respective vectors of which are perpendicular to each other as specific polarization states is also a preferred embodiment. Applied as the retardation film 22 in this case is such a retardation film that a region whose retardation is ½λ and whose optical axis is at 45° with respect to the absorption axis of the polarizing plate 21, and a region whose retardation is zero are patterned.

The retardation film of the present invention can be suitably used as the retardation film 22 having a plurality of regions having different optical characteristics in the same film, and as described in the foregoing, is superior to the case where a conventional retardation film is used from the viewpoints of labor savings upon production of such retardation film, easy formation of the regions, and its excellent heat resistance.

<Liquid Crystal Display Apparatus>

A liquid crystal display apparatus of the present invention has the retardation film of the present invention described in the foregoing. The liquid crystal display apparatus of the present invention can be constructed by using the retardation film of the present invention as part or the entirety of a retardation film in the construction of a known liquid crystal display apparatus. The liquid crystal display apparatus of the present invention is superior to the case where a conventional retardation film is used from the viewpoints of labor savings upon production of the retardation film, easy formation of the regions, and its excellent heat resistance. In particular, an optical characteristic of the retardation film of the present invention remains nearly unchanged even at a general baking temperature for a film in a liquid crystal display apparatus. Accordingly, a liquid crystal display device constructed of various layers can be constructed by providing the retardation film of the present invention at an arbitrary position in the liquid crystal display device.

In the liquid crystal display device of the present invention, the retardation film of the present invention is preferably integrated into a color filter because the film is excellent in terms of easy formation of a fine pattern having different optical characteristics. In the present invention, a substrate in which color filter layers each having a specific spectral transmittance characteristic for selectively transmitting light in a specific wavelength band by means of a principle such as absorption, interference, or scattering and their pattern are formed is referred to as “color filter.”

In the color filter, two or more regions of the color filter layers having different spectral transmittance characteristics are formed for each pixel unit in order that an image may be displayed in color. The color filter is generally formed so that the color filter layers having spectral transmittances for selectively and independently transmitting light beams in red, blue, and green wavelength ranges may be divided into three equal sub-pixels of one pixel for each pixel. In the present invention, however, wavelength ranges to be selectively transmitted in the color filter layers to be applied and the number of sub-pixels into which the layers are divided are not limited.

It should be noted that the color filter layers and the retardation film are preferably provided so as to be close to, or contact, each other in consideration of an influence of parallax. The term “influence of parallax” refers to the shift of an optical path between a color filter layer and a region of the retardation film corresponding to the layer which may occur when the liquid crystal display apparatus is viewed from an oblique direction. The foregoing is preferred from the viewpoint of the prevention of the loss of an effect as a result of the adjustment of an optical characteristic of the retardation film due to such optical path shift.

In the liquid crystal display apparatus of the present invention, sub-pixels divided by the color filter layers having different spectral transmittance characteristics transmit light beams in specific wavelength ranges depending on the respective spectral transmittance characteristics of the color filter layers. The retardation film to be integrated into the color filter can be provided while its retardation or the axial angle of its optical axis is optimized in accordance with such optical design that a characteristic of the liquid crystal display apparatus is improved in correspondence with each of the wavelength ranges of light beams transmitted by sub-pixel units in which the color filter layers having different spectral transmittance characteristics are formed or with a wavelength that represents the wavelength range. Here, the term “wavelength that represents the wavelength range” means an arbitrary wavelength in the wavelength range to be transmitted at a high transmittance in the spectral transmittance characteristics of the color filter layers, and the wavelength may be set in consideration of, for example, the spectral characteristic and luminosity factor of backlight to be used in the liquid crystal display apparatus.

In addition, in, for example, a semitransmission-type liquid crystal display apparatus having a region provided with a reflective plate (which may hereinafter be referred to as “reflective region”) and a region not provided with any reflective plate (which may hereinafter be referred to as “transmissive region”) for each pixel unit so that ambient light and backlight can be used in combination as light sources, the retardation film of the present invention can be provided while the retardation of the retardation film or the axial angle of its optical axis is optimized for each reflective region or transmissive region in accordance with the optical design of each of the reflective region and the transmissive region. That is, the retardation film of the present invention can be provided in the semitransmission-type liquid crystal display apparatus so that regions each obtained by adjusting one or both of a retardation and the axial angle of an optical axis so that desired optical characteristics may be expressed in the reflective region and the transmissive region may be formed on optical paths from both light sources, i.e., the ambient light and the backlight.

Further, in, for example, a semitransmission-type liquid crystal display apparatus in which a reflective region and a transmissive region are formed for each of sub-pixels divided by the color filter layers having different spectral transmittance characteristics as well, the retardation film of the present invention can be provided while the retardation of the retardation film or the axial angle of its optical axis is optimized in accordance with the reflective region and the transmissive region, and optical design corresponding to the representative wavelength of each of the color filter layers corresponding to the regions. That is, the retardation film of the present invention can be provided in the semitransmission-type liquid crystal display apparatus having the color filter layers having different spectral characteristics so that regions each obtained by adjusting one or both of a retardation and the axial angle of an optical axis so that desired optical characteristics may be expressed in the sub-pixels of the color filter layers having different spectral transmittance characteristics, and the reflective region and transmissive region of each sub-pixel may be formed on optical paths from the reflective region and transmissive region of each color filter layer. The retardation film of the present invention can form a region having a desired optical characteristic independently even in such a region to be formed in an additionally fine fashion that a pixel is further divided.

The liquid crystal display apparatus of the present invention into which a patterned retardation film formed of a liquid crystalline polyimide having a photoreactive group is incorporated is described with reference to drawings. Although components are described depending on their placements in the following description, the placements do not mean the order in which the respective components in the liquid crystal display apparatus are produced. The liquid crystal display apparatus to be described below is of, for example, the following form. Respective layers such as an electrode and a liquid crystal alignment film are sequentially laminated on each of illustrated substrates, and these substrates are opposed to each other and then attached to each other with a liquid crystal layer formed of a driving liquid crystal medium interposed therebetween. The apparatus can be produced by a known method for realizing such form.

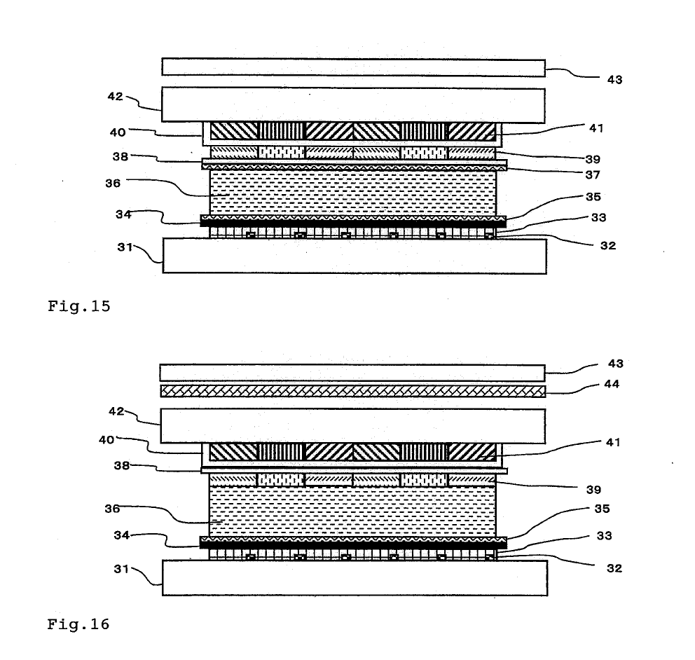

A liquid crystal display apparatus of FIG. 15 is a reflective liquid crystal display apparatus constructed of a plane substrate 31, a switching device 32 placed on the plane substrate 31, an insulating film 33 placed on the switching device 32, a reflective electrode 34 placed on the insulating film 33, a liquid crystal alignment film 35 placed on the reflective electrode 34, a liquid crystal layer 36 formed of a driving liquid crystal medium placed on the liquid crystal alignment film 35, a liquid crystal alignment film 37 placed on the liquid crystal layer 36, a transparent electrode 38 placed on the liquid crystal alignment film 37, a retardation film 39 placed on the transparent electrode 38, an overcoat layer 40 placed on the retardation film 39, color filter layers 41 placed on the overcoat layer 40, a transparent substrate 42 placed on the color filter layers 41, and a polarizing plate 43 placed on the transparent substrate 42. The color filter layers 41 are layers formed by dividing a layer that selectively transmits red, green, and blue light beams into three sub-pixels for each pixel. In addition, the retardation film 39 is a film of the liquid crystalline polyimide having a photoreactive group, and is a film in which a pattern formed of three regions having optical characteristics different from one another depending on the red, green, and blue color filter layers is formed.

Further, a liquid crystal display apparatus of FIG. 16 is a reflective liquid crystal display apparatus constructed of the plane substrate 31, the switching device 32 placed on the plane substrate 31, the insulating film 33 placed on the switching device 32, the reflective electrode 34 placed on the insulating film 33, the liquid crystal alignment film 35 placed on the reflective electrode 34, the liquid crystal layer 36 formed of a driving liquid crystal medium placed on the liquid crystal alignment film 35, the retardation film 39 placed on the liquid crystal layer 36, the transparent electrode 38 placed on the retardation film 39, the overcoat layer 40 placed on the transparent electrode 38, the color filter layers 41 placed on the overcoat layer 40, the transparent substrate 42 placed on the color filter layers 41, a retardation film 44 placed on the transparent substrate 42, and the polarizing plate 43 placed on the retardation film 44. The retardation film 44 is a retardation film having uniform optical characteristics, and is a retardation film formed of, for example, a retardation film formed of a polymerizable liquid crystal material and a liquid crystal alignment film.

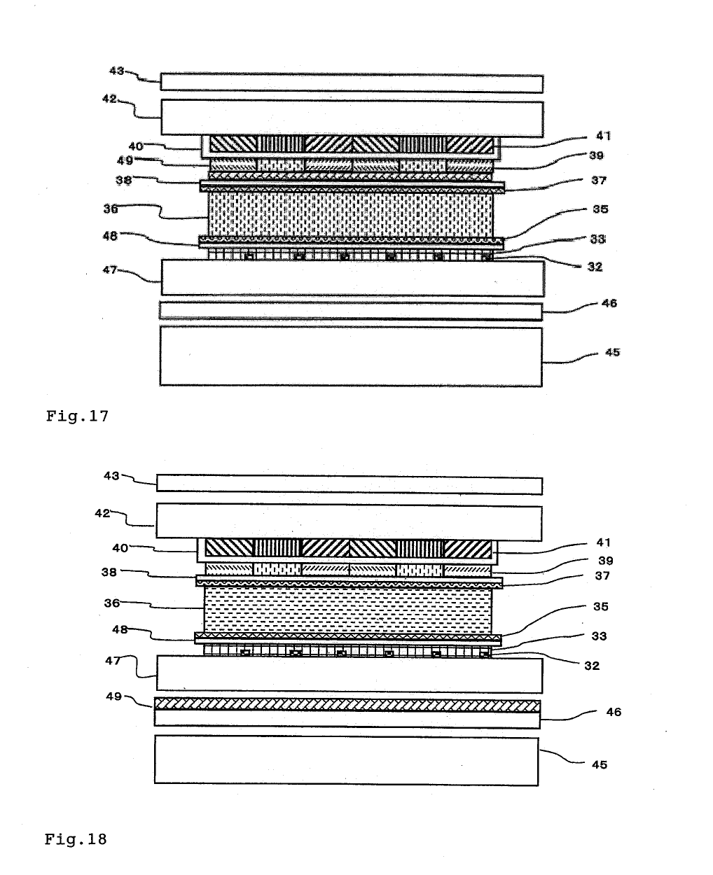

In addition, a liquid crystal display apparatus of FIG. 17 is a transmission-type liquid crystal display apparatus constructed of a backlight unit 45 as a light source, a polarizing plate 46 placed on an optical path from the backlight unit 45, a transparent substrate 47 placed on the polarizing plate 46, the switching device 32 placed on the transparent substrate 47, the insulating film 33 placed on the switching device 32, a transparent electrode 48 placed on the insulating film 33, the liquid crystal alignment film 35 placed on the transparent electrode 48, the liquid crystal layer 36 formed of a driving liquid crystal medium placed on the liquid crystal alignment film 35, the liquid crystal alignment film 37 placed on the liquid crystal layer 36, the transparent electrode 38 placed on the liquid crystal alignment film 37, a retardation film 49 placed on the transparent electrode 38, the retardation film 39 placed on the retardation film 49, the overcoat layer 40 placed on the retardation film 39, the color filter layers 41 placed on the overcoat layer 40, the transparent substrate 42 placed on the color filter layers 41, and the polarizing plate 43 placed on the transparent substrate 42. The retardation film 49 is a retardation film having uniform optical characteristics, and is a retardation film formed of, for example, a polymerizable liquid crystal material obtained through the alignment of a polymerizable liquid crystal compound by the retardation film 39.

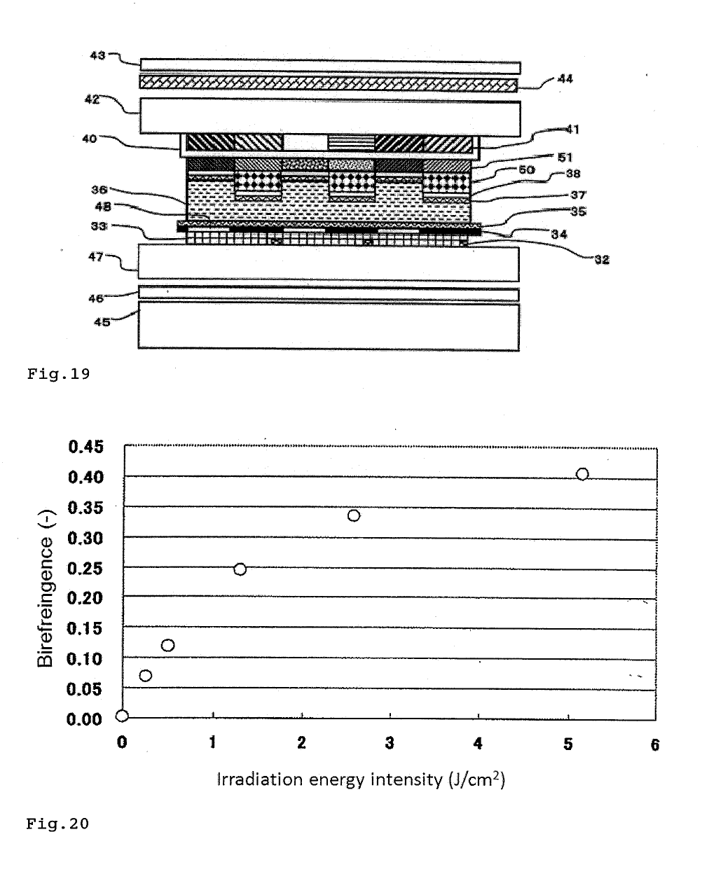

In addition, a liquid crystal display apparatus of FIG. 18 is a transmission-type liquid crystal display apparatus constructed of the backlight unit 45 as a light source, the polarizing plate 46 placed on an optical path from the backlight unit 45, the retardation film 44 placed on the polarizing plate 46, the transparent substrate 47 placed on the retardation film 44, the switching device 32 placed on the transparent substrate 47, the insulating film 33 placed on the switching device 32, the transparent electrode 48 placed on the insulating film 33, the liquid crystal alignment film 35 placed on the transparent electrode 48, the liquid crystal layer 36 formed of a driving liquid crystal medium placed on the liquid crystal alignment film 35, the liquid crystal alignment film 37 placed on the liquid crystal layer 36, the transparent electrode 38 placed on the liquid crystal alignment film 37, the retardation film 39 placed on the transparent electrode 38, the overcoat layer 40 placed on the retardation film 39, the color filter layers 41 placed on the overcoat layer 40, the transparent substrate 42 placed on the color filter layers 41, and the polarizing plate 43 placed on the transparent substrate 42.

In addition, a liquid crystal display apparatus of FIG. 19 is a semitransmission-type liquid crystal display apparatus constructed of the backlight unit 45 as a light source, the polarizing plate 46 placed on an optical path from the backlight unit 45, the transparent substrate 47 placed on the polarizing plate 46, the switching device 32 placed on the transparent substrate 47, the insulating film 33 placed on the switching device 32, the transparent electrode 48 and the reflective electrode 34 placed on the insulating film 33, the liquid crystal alignment film 35 placed on the transparent electrode 48 and the reflective electrode 34, the liquid crystal layer 36 formed of a driving liquid crystal medium placed on the liquid crystal alignment film 35, the liquid crystal alignment film 37 placed on the liquid crystal layer 36, the transparent electrode placed on the liquid crystal alignment film 37, a cell thickness-adjusting layer 50 placed on the transparent electrode 38 above the reflective electrode 34, a retardation film 51 placed on the transparent electrode 38 above the transparent electrode 48 and the cell thickness-adjusting layer 50, the overcoat layer 40 placed on the retardation film 51, the color filter layers 41 placed on the overcoat layer 40, the transparent substrate 42 placed on the color filter layers 41, the retardation film 44 placed on the transparent substrate 42, and the polarizing plate 43 placed on the retardation film 44. The transparent electrode 48 and the reflective electrode 34 are placed on the insulating film 33 according to a predetermined pattern so that respective regions corresponding to the respective sub-pixels in each pixel may be divided by these electrodes. The cell thickness-adjusting layer 50 is a layer based on a resin having light transmittance to be placed in correspondence with a region corresponding to the reflective electrode 34 in the region corresponding to each sub-pixel. The retardation film 51 is a film of the liquid crystalline polyimide having a photoreactive group, and is a film having the following pattern. Formed in each of three regions having optical characteristics different from one another in accordance with the respective sub-pixels are two regions having optical characteristics further different from the above-mentioned optical characteristics in accordance with the transparent electrode 48 and the reflective electrode 34. That is, the retardation film is a film having such a pattern that six regions having different optical characteristics are formed in each pixel.

Each illustrated liquid crystal display apparatus has the two plane substrates 31 (47) and 42 arrayed so as to be parallel to each other, and at least one of the substrates is transparent. The transparent electrode 38 and the liquid crystal alignment film 37 are formed on at least one of the substrates, and the transparent electrode 48 or the reflective electrode 34 and the liquid crystal alignment film 35 are formed on the other substrate as well as required.

The backlight unit 45 is utilized as a light source in a liquid crystal display apparatus in which the transparent electrode 38 is formed only on one of the substrates or the transparent electrodes 38 and 48 are formed on both substrates, and such liquid crystal display apparatus is referred to as “transmission-type liquid crystal display apparatus” (FIGS. 17 and 18). In addition, a liquid crystal display apparatus utilizing ambient light as a light source is referred to as “reflective liquid crystal display apparatus.” The utilization of the ambient light as a light source requires a reflective plate, and such a mode that the reflective plate is provided outside a liquid crystal cell (not shown) and such a mode that the reflective electrode 34 that functions as the reflective plate and as an electrode is formed in the liquid crystal cell (FIGS. 15 and 16) are available. Of those, the latter is preferred because an influence of parallax is small.

The liquid crystal layer 36 formed of a driving liquid crystal medium is interposed between the two opposing plane substrates 31 (47) and 42. The liquid crystal layer 36 shows at least two different alignment states by virtue of, for example, the liquid crystal alignment film 35 or 37, and voltages applied to the opposing electrodes 34 (48) and 38. The liquid crystal cell formed of the substrates and a layer or film therebetween has these structures.

In the present invention, when a film or structural body to be formed or placed on the plane substrate 31 (47) or 42 is on the side of the liquid crystal layer 36, the expression “the film or structural body is formed or placed inside the liquid crystal cell” is used. In addition, when a film or structural body to be formed or placed on the plane substrate 31 (47) or 42 is on the side opposite to the liquid crystal layer 36, the expression “the film or structural body is formed or placed outside the liquid crystal cell” is used.

The switching device 32 typified by a TFT that enables one to adjust an applied voltage for each pixel as required and the color filter layers 41 are formed in the liquid crystal cell, and the overcoat layer 40 and the insulating film 33 are provided thereon as required for the purpose of, for example, planarization.

In the present invention, the transparent substrate 42 provided with the color filter layers 41 and having formed thereon the overcoat layer 40, the cell thickness-adjusting layer 50, a black matrix (not shown), or the like as required is referred to as “color filter” or “color filter substrate.” The color filter layers 41 each have a specific spectral transmittance characteristic for selectively transmitting light in a specific wavelength band by means of a principle such as absorption, interference, or scattering.

The outside of the liquid crystal cell is provided with a light source called the backlight unit 45, or at least one polarizing plate 43 or 46 as required. The polarizing plate 43 or 46 is installed on the plane substrate 31 (47) or 42 outside the liquid crystal cell. In addition, the retardation film 39 based on the liquid crystalline polyimide containing a photoreactive group is formed on the plane substrate 31 (47) or 42 at a position sandwiched between the liquid crystal layer 36 and the polarizing plate 43 or 46.

In a liquid crystal display apparatus in which two or more regions of the color filter layers 41 having different spectral transmittance characteristics are patterned, it is effective to provide the retardation film 39 with the magnitude of its retardation or the angle of its optical axis optimized for a representative wavelength λ₁, λ₂, . . . , or λₖ in a wavelength band corresponding to each color filter layer 41 while patterning the film in correspondence with the pattern of the color filter layers 41.

Further, the patterned retardation film 39 is preferably formed inside the liquid crystal cell in consideration of an influence of parallax, and is more preferably formed on the side of the liquid crystal layer 36 on the color filter layers 41 formed on the transparent substrate 42 with the overcoat layer 40 interposed therebetween as required so that the film may be placed adjacent to the color filter layers 41.

A liquid crystal display apparatus in which a region provided with a reflective plate and a region not provided with any reflective plate are formed per one pixel can use the backlight unit 45 and ambient light in combination as light sources. Such liquid crystal display apparatus is referred to as “semitransmission-type liquid crystal display apparatus.” FIG. 19 illustrates a liquid crystal display apparatus in which the pattern of the transparent electrode 48 and the reflective electrode 34 is formed per one pixel as an example of the semitransmission-type liquid crystal display apparatus. In such semitransmission-type liquid crystal display apparatus, the magnitude of the retardation of the retardation film 51 or the angle of its optical axis is preferably optimized in correspondence with the pattern of the reflective electrode 34 and the transparent electrode 48, that is, the region provided with the reflective plate and the region not provided with any reflective plate. In a more preferred embodiment, the magnitude of the retardation, or the angle of the optical axis, of the region provided with the reflective plate or the region not provided with any reflective plate is also further optimized in correspondence with each of the color filter layers 41 having different spectral transmittance characteristics for a representative wavelength λ₁, λ₂, . . . , or λₖ in the wavelength band of the layer.

When the patterned retardation film 39 based on the liquid crystalline polyimide containing a photoreactive group is formed so as to be adjacent to the liquid crystal layer 36 (FIG. 16), the patterned retardation film 39 can be caused to serve as an alignment film for a driving liquid crystal medium in the liquid crystal layer 36 as well. In this case, it is also useful to subject the surface of the retardation film 39 based on the liquid crystalline polyimide containing a photoreactive group to a rubbing treatment or ultraviolet irradiation for readjusting an anchoring energy on the driving liquid crystal medium. When such a construction that the retardation film 39 is placed adjacent to the liquid crystal layer 36 is adopted, a film that brings together an optical function called a retardation film and a function of aligning a driving liquid crystal medium is obtained by substantially the same production steps as those in the case where an alignment film is provided by using a conventional aligning agent. The foregoing is an advantage of the liquid crystalline polyimide containing a photoreactive group.

Such a structure that the non-patterned retardation film 44 or 49 as well as the patterned retardation film 39 formed of the liquid crystalline polyimide containing a photoreactive group is separately added is also a preferred embodiment. The non-patterned retardation film 44 or 49 is provided on the plane substrate 31 (47) or 42 at a position sandwiched between the liquid crystal layer 36 and the polarizing plate 43 or 46. Further, the film is placed outside the liquid crystal cell or inside the liquid crystal cell. The retardation film formed inside the liquid crystal cell is formed with a liquid crystalline material such as a polymerizable liquid crystal material or a lyotropic liquid crystal material as well as the liquid crystalline polyimide containing a photoreactive group. Alternatively, when the thin film is molded by a solvent casting method, the film is formed with a polyamideimide-based resin, polyether ether ketone-based resin, or polyimide-based resin having a specific structure with which such a retardation film that a molecule of the resin has an optical axis in the thickness direction of the thin film as a result of its spontaneous alignment in the evaporation process of the solvent is obtained.

When the retardation film 49 based on a liquid crystalline material is formed on the patterned retardation film based on the liquid crystalline polyimide containing a photoreactive group (FIG. 17), the patterned retardation film 39 can be caused to serve as an alignment film for the liquid crystalline material in the retardation film 49 as well. In this case, it is also useful to subject the surface of the retardation film 39 based on the liquid crystalline polyimide containing a photoreactive group to a rubbing treatment or ultraviolet irradiation for readjusting an anchoring energy on the liquid crystalline material. When such a construction that the retardation film 39 is placed adjacent to the retardation film 49 based on a liquid crystalline material is adopted, a film that brings together an optical function called a retardation film and a function of aligning a liquid crystalline material is obtained by substantially the same production steps as those in the case where an alignment film is provided by using a conventional aligning agent. The foregoing is an advantage of the liquid crystalline polyimide containing a photoreactive group.

When the patterned retardation film 39 based on the liquid crystalline polyimide containing a photoreactive group is formed inside the liquid crystal cell, the non-patterned retardation film 49, the transparent electrode 38, the liquid crystal alignment film 37, or the cell thickness-adjusting layer 50 is further formed on the patterned retardation film 39 (51) in an arbitrary fashion in some cases. A process for forming any such film or layer involves such a thermal load that a high treatment temperature exceeding 200° C. is applied for a certain time period. A characteristic of the retardation film 39 (51) based on the liquid crystalline polyimide containing a photoreactive group such as a retardation changes with the thermal load caused by the foregoing process to a small extent because the film is excellent in heat resistance. The foregoing is also an advantage of the liquid crystalline polyimide containing a photoreactive group.

(Polarization Hologram)

The retardation film of the present invention can find use in various optical devices having retardation films as well as the forms described in the foregoing. A polarization hologram is given as an example of such optical devices. Such polarization hologram can be constructed by replacing a retardation film formed of a liquid crystal layer and a liquid crystal alignment layer in a known polarization hologram with the retardation film of the present invention. For example, the polarization hologram can be constructed by replacing an optical alignment layer (2) and a liquid crystal composition (3) illustrated in FIG. 1 of Japanese Patent Translation Publication No. 2008-532085 with the retardation film of the present invention.

### EXAMPLES

Hereinafter, examples of the present invention are described. The present invention is not limited only to the following examples.

First, evaluation methods for a material and a retardation film employed in the examples are described.

### <Viscosity>

The viscosity of a polyamic acid solution was measured with a rotational viscometer (TV-22L manufactured by Toki Sangyo Co., Ltd.).

### <Weight-Average Molecular Weight (Mw)>

The weight-average molecular weight (Mw) of the polyamic acid was measured by employing gel permeation chromatography (GPC) with DMF containing 0.6 wt % of phosphoric acid as an eluent and polystyrene as a standard solution at a column temperature of 50° C. A gel permeation chromatograph system manufactured by JASCO Corporation (HPLC pump: PU-2080, column oven: 865-CO, ultraviolet-visible light detector: UV-2075, differential refractometer detector: RI-2031) was used in GPC, and a Shodex GF-7M HQ (manufactured by Showa Denko K.K.) was used as a column.

### <Thickness of Retardation Film>

The thickness of a retardation film was determined by: shaving part of the retardation film from a substrate on which the retardation film was formed; and measuring the step height with a surface measurement profiler (Alpha-Step 1Q/manufactured by KLA-Tencor Corporation).

<Retardation of Retardation Film and Wavelength Dependence of its Δn>

The retardation of the retardation film and the wavelength dependence of its Δn were measured with an ellipsometer (OptiPro/manufactured by SHINTECH, Inc.).

### Example 1

### <Synthesis of Compound (VII-4-1)>

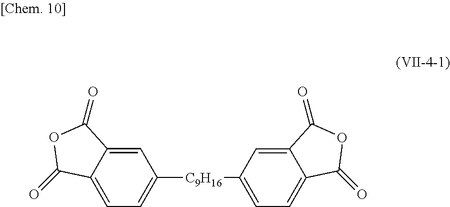

A mixture of 4-bromophthalic acid diethyl ester (50 g, 166 mmol), 1,7-octadiyne (8.7 g, 82 mmol), dichlorotriphenylphosphinepalladium(II) (290 mg, 0.41 mmol), and copper iodide (158 mmol, 0.83 mmol) was refluxed in a stream of nitrogen in triethylamine (200 mL) for 4 hours. After the completion of the reaction, toluene (500 mL) and pure water (500 mL) were added to perform extraction. The organic phase was washed with pure water (300 mL) once, and was then dried with anhydrous magnesium sulfate. The resultant organic phase was filtrated and the solvent was removed by distillation under reduced pressure. Thus, 1,4-bis(3,4-dicarboxyphenyl)ethynylbutane tetraethyl ester as a target product was obtained in an amount of 42 g in 95% yield. The compound was directly used in the next reaction without being purified.

5% Pd/C (2.1 g) was added to 1,4-bis(3,4-dicarboxyphenyl)ethynylbutane tetraethyl ester (42 g, 77 mmol), and then the mixture was subjected to a hydrogenation reaction in a mixed solvent of toluene and ethanol (300 mL/300 mL) at a hydrogen pressure of 720 MPa. After the completion of the reaction, the catalyst was separated by filtration and the solvent was removed by distillation under reduced pressure. The remainder was purified by column chromatography (silica gel/toluene:ethyl acetate=10:1). Thus, 1,8-bis(3,4-dicarboxyphenyl) octane tetraethyl ester as a target was obtained in an amount of 43 g in 100% yield.

1,8-Bis(3,4-dicarboxyphenyl) octane tetraethyl ester (43 g, 77 mmol) was dissolved in ethanol (250 mL). A 5.7% aqueous solution of sodium hydroxide (250 mL) was added to the solution, and then the mixture was refluxed for 2 hours. After the reaction, the solvent was removed by distillation under reduced pressure, and then concentrated hydrochloric acid was added to the remainder until the pH of the resultant mixture became 1. The resultant precipitate was filtrated, and was then washed with pure water (200 mL) three times. The resultant crystal was dried under reduced pressure. Thus, 1,8-bis(3,4-dicarboxyphenyl)octane was obtained in an amount of 31 g in 90% yield.

Acetic anhydride (50 mL) was added to 1,8-bis(3,4-dicarboxyphenyl)octane (10 g, 23 mmol), and then the mixture was refluxed for 2 hours. After acetic anhydride had been removed by distillation under reduced pressure, cyclohexane (50 mL) was added to the remainder and the resultant precipitate was filtrated. The resultant crystal was dried under reduced pressure. Thus, Compound (VII-4-1) having a melting point of 109.7 to 111.2° C. was obtained in an amount of 9.2 g in 97% yield. The resultant compound was subjected to ¹H-NMR measurement. As a result, the following spectrum was obtained, and hence it was confirmed that the target product was synthesized. ¹H-NMR (500 Hz, CDCl₃); 5 (ppm) 7.92 (d, 4H, J=7.80 Hz), 7.70 (d, 4H, J=8.1 Hz), 2.82 (t, 4H, J=7.65 Hz), 1.3-1.7 (m, 12H)

<Synthesis of Polyamic Acid and Preparation of Polyamic Acid Solution>

Compound (VI-1) (0.1661 g, 0.7827 mmol) below was dissolved in N-methyl-2-pyrrolidone (hereinafter referred to as “NMP,” 3.0 g), and then Compound (VII-4-1) (0.3182 g, 0.7829 mmol) was added to the solution while the temperature of the solution was kept at room temperature or less. After the mixture had been stirred overnight, NMP (3.5 g) and ethylene glycol monobutyl ether (BSC, 3.0 g) were added to the mixture. Thus, a solution (A-1) containing about 5 wt % of a polyamic acid as a precursor of a liquid crystalline polyimide having a photoreactive group was obtained. The solution (A-1) had a viscosity of 20.7 mPa·s and the polyamic acid had a weight-average molecular weight of 58,000. Further, a solution whose polyamic acid content was 3 wt % was prepared by diluting the solution with a mixture containing NMP and BSC at a weight ratio of 1/1. The solution obtained by the dilution is defined as a polyamic acid solution (A-2). It should be noted that a commercial product that had been purified was used as Compound (VI-1).

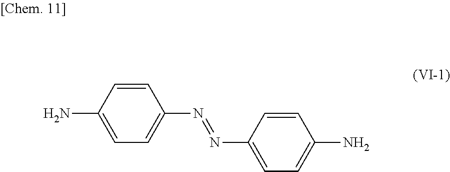

<Production of Retardation Film 1 and Confirmation of its Optical Characteristics>

The solution (A-1) was applied (2,000 rpm, 15 seconds) to a glass substrate with a spinner, and was then heated at 80° C. for 3 minutes so that the solvent was evaporated. After that, the resultant was irradiated with ultraviolet light through a polarizing plate so as to be irradiated with linearly polarized ultraviolet light (illuminance: 9 mW/cm², irradiation energy intensity: 5 J/cm²). The substrate that had been irradiated with the polarized ultraviolet light was subjected to a heat treatment in an oven at 230° C. for 15 minutes. Thus, a retardation film 1 having a thickness of 175 nm was obtained. The retardation Re of the retardation film 1 was measured to be 71 nm (λ=550 nm). Thus, it was confirmed that the retardation film 1 was a film based on a polyimide having liquid crystallinity obtained by heating and imidating a polyamic acid having a photoreactive group. The orientation of an optical axis in the retardation film 1 was substantially parallel to the direction of the absorption axis of the polarizing plate upon irradiation with the polarized ultraviolet light. Thus, it was confirmed that the control of the angle of the optical axis in the retardation film 1 was attained by the polarization state of ultraviolet light to be applied.

It should be noted that the orientation of the optical axis of the retardation film 1 was identified by measurement with an ellipsometer (OptiPro/manufactured by SHINTECH, Inc.).

<Test of Retardation Film 1 for its Heat Resistance>

The retardation film 1 was left to stand in an oven at 230° C. for 2 hours. Then, the film was taken out of the oven and its temperature was returned to room temperature. After that, its retardation was measured. As a result, the change was less than 1 nm as compared with the retardation before the loading into the oven at 230° C. The foregoing confirmed that the retardation film 1 was excellent in heat resistance.

<Control of Retardation (Birefringence) by Irradiation Energy Intensity of Polarized Ultraviolet Light>

A plurality of retardation film samples were produced while an irradiation energy intensity for a coating film of the solution (A-1) was adjusted by changing the time period for which the coating film was irradiated with the polarized ultraviolet light. Then, a birefringence in each sample was determined by measuring a thickness and a retardation in each sample. FIG. 20 shows the results. FIG. 20 confirmed that the control of the magnitude of the retardation of a retardation film was attained by adjusting the irradiation energy intensity for the coating film. FIG. 20 elucidated that the magnitude of the retardation was attributable to a difference in birefringence in the retardation film. Here, the birefringence is a value obtained by dividing the actually measured retardation by the actually measured thickness.

As is apparent from the results, even when the coating film has a uniform thickness, the coating film can be formed into a retardation film, in which a plurality of regions having different magnitudes of retardations are patterned, by irradiating the coating film with light beams having different irradiation energy intensities together with masking with a photomask.

### Example 2

### <Preparation of Polymerizable (Cholesteric) Liquid Crystal Material Solution (B-1) for Obtaining Green Selective Reflective Film>

A composition formed of 82.2 wt % of Compound (P-1) below, 4.8 wt % of Compound (P-2) below, 9.7 wt % of Compound (P-3) below, and 3.3 wt % of Compound (P-4) below was defined as a (MIX1). A CPI-110P (San-Apro Ltd.) having a weight ratio of 0.030 was added to the (MIX1), and then cyclopentanone having a weight ratio of 2.333 was added to the mixture. Thus, a cyclopentanone solution (B-1) having a solute concentration of 30 wt % was obtained. It should be noted that Compound (P-1) was synthesized by a method described in Macromolecules, 1993, 26(6), 244. In addition, Compound (P-2) and Compound (P-3) were each synthesized by a method described in Japanese Patent Application Laid-open No. 2005-60373. Further, Compound (P-4) was synthesized by a method described in Japanese Patent Application Laid-open No. 2005-263778.

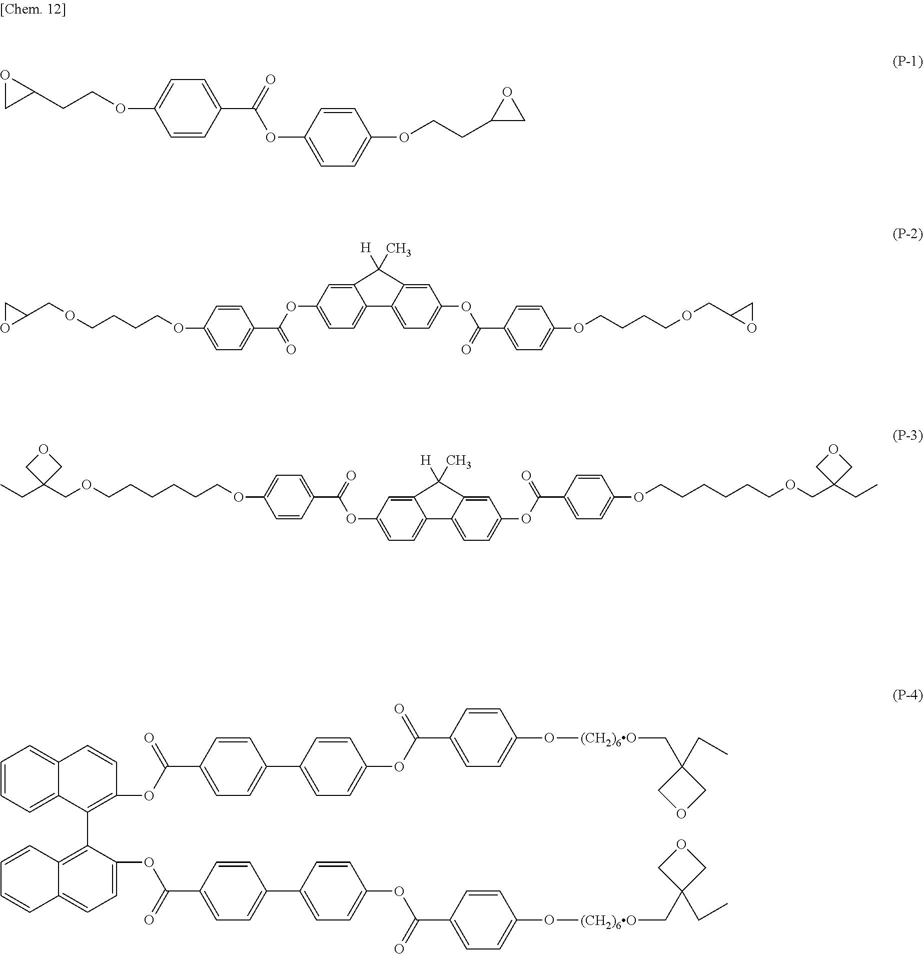

<Production of Green Selective Reflective Film by Application of Polymerizable (Cholesteric) Liquid Crystal Material Solution (B-1) onto Retardation Film 1 and its Polymerization>

The solution (B-1) was applied to the retardation film 1 with a spinner under the conditions of 1,500 rpm and 15 seconds. Further, the resultant coating film was heated at 80° C. for 3 minutes so that the solvent was evaporated. After that, the resultant film was irradiated with ultraviolet light (illuminance: 25 mW/cm², dose: 0.75 J/cm²) so that a green selective reflective film was formed. The resultant film was of a mirror surface shape, and the observation of the film with a polarization microscope confirmed a Grandjean texture. That is, the polymerizable (cholesteric) liquid crystal material had such alignment that its spiral axis was aligned with the normal direction of the substrate, and hence it was confirmed that the retardation film 1 had a function of aligning the polymerizable (cholesteric) liquid crystal material as well.

### Example 3

<Preparation of Solution (B-2) of Polymerizable Liquid Crystal Material Having Rod-Shaped Mesogen Skeleton with which Positive A-Plate is Obtained by Immobilizing Homogeneous Alignment>

A composition formed of 75 wt % of Compound (P-5) below and 25 wt % of Compound (P-6) below was defined as a (MIX2). An IRGACURE 907 (Ciba Japan K.K.) having a weight ratio of 0.03 was added to the (MIX2), and then cyclopentanone having a weight ratio of 2.333 was added to the mixture. Thus, a cyclopentanone solution (B-2) having a solute concentration of 30 wt % was obtained. It should be noted that Compound (P-5) was synthesized by a method described in Japanese Patent Application Laid-open No. 2006-307150. In addition, Compound (P-6) was synthesized by a method described in Macromolecules, 1990, 23(17), 3938.

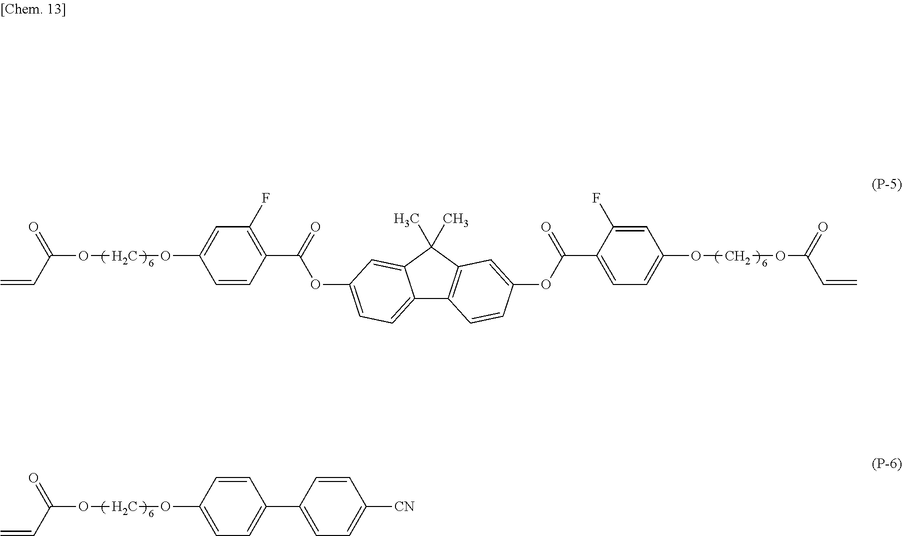

<Production of Composite Retardation Film Having Retardation Film of Positive A-Plate by Application of Solution (B-2) Onto Retardation Film (I) and its Polymerization>

### (Retardation Film (I))

A retardation film (I) was produced by applying the solution (A-2) to a glass substrate same as the production of the retardation film 1 of Example 1. The irradiation energy of polarized ultraviolet light to be applied to a film of the solution (A-2) before baking was set to zero. The resultant retardation film (I) had a thickness of 83 nm. In addition, the retardation of the retardation film (I) at each of the wavelengths of light beams corresponding to blue, green, and red colors (450 nm, 550 nm, and 650 nm) was measured. A table below shows the retardations of the retardation film (I).

TABLE 3

| | | I-B | I-G | I-R |
|---|---|---|---|---|
| Measuring wavelength | (nm) | 450 | 550 | 650 |
| Retardation | (nm) | 0.2 | 0.1 | 0.1 |

### (Retardation Film (II))

A retardation film (II) was produced in the same manner as in the retardation film (I) except that the irradiation energy intensity of the polarized ultraviolet light to be applied to the film of the solution (A-2) before baking was set to 2.6 J/cm². The resultant retardation film (II) had a thickness of 83 nm. In addition, the retardations of the retardation film (II) were measured in the same manner as in the retardation film (I). A table below shows the retardations of the retardation film (II). When the retardation film (I) and the retardation film (II) were compared with each other in terms of a value obtained by dividing a retardation by a thickness, i.e., Δn, the films each had a substantially equal value of about 0.4. Accordingly, it was confirmed by the comparison with the retardation film (I) of Example 1 that the adjustment of the retardation was attained by changing the thickness. It should be noted that the same magnitude of the Δn was obtained in the retardation film (II) even when the irradiation energy intensity of the polarized ultraviolet light to be applied was smaller because the film had a smaller thickness than that of the retardation film (I).

TABLE 4

| | | II-B | II-G | II-R |
|---|---|---|---|---|
| Measuring wavelength | (nm) | 450 | 550 | 650 |
| Retardation | (nm) | 39.4 | 33.2 | 29.0 |

### (Retardation Film (III))

The retardation film (I) was rubbed with a rubbing apparatus RM-50 manufactured by EHC K.K. under the following conditions in one direction: a bristle indentation of a rubbing cloth (having a bristle length of 1.8 mm and made of rayon) of 0.6 mm, a number of revolutions of a roller of 1,400 rpm, and a stage moving speed of 0.6 m/min. The solution (B-2) was applied onto the resultant with a spinner under the conditions of 1,800 rpm and 15 seconds. Further, the resultant coating film was heated at 80° C. for 3 minutes so that the solvent was evaporated. After that, the resultant coating film was irradiated with ultraviolet light (illuminance: 25 mW/cm², dose: 0.75 J/cm²) so as to be immobilized. Thus, a retardation film formed of a polymerizable liquid crystal material horizontally aligned with the retardation film (I) was produced on the substrate. The retardation film is defined as a retardation film (III). The resultant retardation film (III) had a total thickness of 775 nm. In addition, the retardations of the retardation film (III) were measured in the same manner as in the retardation film (I). A table below shows the retardations of the retardation film (III).

TABLE 5

| | | III-B | III-G | III-R |
|---|---|---|---|---|
| Measuring wavelength | (nm) | 450 | 550 | 650 |
| Retardation | (nm) | 140.9 | 124.5 | 118.3 |

### (Retardation Film (IV))

The retardation film (II) was rubbed in a direction parallel to its slow axis under the same conditions as those at the time of the production of the retardation film (III), and then the solution (B-2) was applied and immobilized onto the film under the same conditions as those of the production of the retardation film (III). Thus, a retardation film formed of a polymerizable liquid crystal material horizontally aligned with the retardation film (II) was produced on the substrate. The retardation film is defined as a retardation film (IV). The resultant retardation film (IV) had a thickness of 779 nm, which was substantially the same as the thickness of the retardation film (III). In addition, the retardations of the retardation film (IV) were measured in the same manner as in the retardation film (I). A table below shows the retardations of the retardation film (IV).

TABLE 6

| | | IV-B | IV-G | IV-R |
|---|---|---|---|---|
| Measuring wavelength | (nm) | 450 | 550 | 650 |
| Retardation | (nm) | 181.2 | 156.7 | 146.2 |

### (Retardation Film (V))

The retardation film (II) was rubbed in a direction perpendicular to its slow axis under the same conditions as those at the time of the production of the retardation film (III), and then the solution (B-2) was applied and immobilized onto the film under the same conditions as those of the production of the retardation film (III). Thus, a retardation film formed of a polymerizable liquid crystal material horizontally aligned with the retardation film (II) was produced on the substrate. The retardation film is defined as a retardation film (V). The resultant retardation film (V) had a thickness of 772 nm, which was substantially the same as the thickness of the retardation film (III). In addition, the retardations of the retardation film (V) were measured in the same manner as in the retardation film (I). A table below shows the retardations of the retardation film (V).

TABLE 7

| | | V-B | V-G | V-R |
|---|---|---|---|---|
| Measuring wavelength | (nm) | 450 | 550 | 650 |
| Retardation | (nm) | 102.1 | 92.3 | 86.5 |

Described next is a useful example in which a composite retardation film based on a retardation film based on a liquid crystalline polyimide containing a photoreactive group in which a retardation or an optical axis is patterned and a non-patterned retardation film formed on the retardation film is applied to a liquid crystal display apparatus having color filter layers having different spectral transmittances on the basis of the above-mentioned results.

Assumed as a liquid crystal display apparatus having color filter layers having different spectral transmittances is a liquid crystal display apparatus having a blue pixel having a color filter layer that selectively transmits light having a wavelength corresponding to a blue color (around 450 nm), a green pixel having a color filter layer that selectively transmits light having a wavelength corresponding to a green color (around 550 nm), and a red pixel having a color filter layer that selectively transmits light having a wavelength corresponding to a red color (around 650 nm), and the pattern of the color filter layers.

Observed first is a characteristic of a composite retardation film having a retardation film of a liquid crystalline polyimide containing a photoreactive group in which a retardation or an optical axis is not patterned and a retardation film corresponding to a positive A-plate based on a polymerizable liquid crystal material formed on the film.

When a retardation at a representative wavelength of the blue pixel of 450 nm is represented by Re (λ=450 nm), a retardation at a representative wavelength of the green pixel of 550 nm is represented by Re (λ=550 nm), and a retardation at a representative wavelength of the red pixel of 650 nm is represented by Re (λ=650 nm), a relationship of Re (λ=450 nm)>Re (λ=550 nm)>Re (λ=650 nm) is established in each of the composite retardation films (III) to (V) as shown in Tables 5 to 7.

Observed next is a characteristic of a composite retardation film having a retardation film of a liquid crystalline polyimide containing a photoreactive group in which a retardation and an optical axis are patterned and a retardation film corresponding to a positive A-plate based on a polymerizable liquid crystal material formed on the film.

Composite retardation films corresponding to blue, green, and red pixels can each be selected by selecting one of the composite retardation films (III) to (V) so that at least one of the films may differ from the other two films.

For example, when the composite retardation film (V) is selected in correspondence with the blue pixel, the composite retardation film (III) is selected in correspondence with the green pixel, and the composite retardation film (IV) is selected in correspondence with the red pixel, as can be seen from the foregoing results of the evaluations of the composite retardation films (III) to (V), the following characteristics are obtained as the characteristics of the composite retardation films corresponding to the blue, green, and red pixels: a retardation of 102.1 nm (corresponding to V-B) at a representative wavelength of 450 nm in the blue pixel, a retardation of 124.5 nm (corresponding to III-G) at a representative wavelength of 550 nm in the green pixel, and a retardation of 146.2 nm (corresponding to IV-R) at a representative wavelength of 650 nm in the red pixel. That is, a relationship of Re (λ=450 nm)<Re (λ=550 nm)<Re (λ=650 nm) was obtained. Accordingly, it was elucidated that a characteristic that was not obtained with the retardation film in which the retardation or the optical axis was not patterned was obtained.

A retardation film in which such relationship is obtained can be obtained by, for example, the following. The solution (A-2) is applied to a color filter layer in which blue, red, and green colored layers are patterned. The resultant coating film is irradiated with polarized ultraviolet light in a predetermined polarization direction at a proper irradiation energy intensity through a mask having a pattern corresponding to the blue colored layer so that a polyimide may be aligned in a direction perpendicular to a subsequent rubbing direction to be described later. Then, the film is irradiated with polarized ultraviolet light in a predetermined polarization direction at a proper irradiation energy intensity through a mask having a pattern corresponding to the red colored layer so that the polyimide may be aligned in a direction parallel to the subsequent rubbing direction. The coating film is baked so that a liquid crystalline polyimide film may be formed, and then the resultant film is rubbed in the one specific direction described in the foregoing. The solution (B-2) is applied and immobilized to the surface of the rubbed film so that a retardation film formed of a horizontally aligned polymerizable liquid crystal material may be formed on the surface of the liquid crystalline polyimide film described in the foregoing.

It was confirmed from the foregoing that the formation of the following composite retardation film on a color filter having a color filter layer provided with two or more regions having different absorption spectral characteristics was attained. A pattern in which the orientation of an optical axis and the magnitude of a retardation were adjusted in an additionally proper fashion in correspondence with the regions of the color filter layer having different absorption spectral characteristics was formed in the composite retardation film.

Next, a function and effect of a retardation film based on a liquid crystalline polyimide containing a photoreactive group in which an optical axis and a retardation were patterned in an optical device or liquid crystal display apparatus to which the film was applied were each confirmed by an optical simulation. It should be noted that an LCD Master Ver. 6.23 manufactured by SHINTECH, Inc. was used in the optical calculations.

It should be noted that Table 8 shows a retardation film formed of each material used in those calculations and the wavelength dependence of its Δn.

In Table 8, the “p A-plate (I)” represents a retardation film of a positive A-plate formed of a liquid crystalline polyimide having a photoreactive group, and the wavelength dependence of its Δn is based on the results of Table 4 of Example 3. In addition, the axial angle of the optical axis and the magnitude of the retardation Re provided by the respective optical calculations are values obtained by optimizing parameters such as the orientation and irradiation energy intensity of polarized ultraviolet light, and a thickness upon production of the retardation film on the basis of the results of the foregoing example.

In Table 8, the “p A-plate (II)” represents a retardation film of a positive A-plate formed of a homogeneously aligned polymerizable liquid crystal material, and the wavelength dependence of its Δn is based on the results of Table 5 of Example 3. In addition, the magnitude of the retardation Re provided by each optical calculation is a value within a range obtained by optimizing a parameter such as a thickness upon production of the retardation film on the basis of the results of the foregoing example.

In Table 8, the “n C-plate” represents a retardation film of a negative C-plate formed of a spirally aligned polymerizable liquid crystal material, and the wavelength dependence of its Δn is a value obtained by producing a film of a composition described in, for example, Japanese Patent Application Laid-open No. 2005-263778 and subjecting the film to measurement. In addition, the magnitude of the retardation Rth provided by each optical calculation is a value obtained by optimizing a parameter such as a thickness upon production of the retardation film.

In Table 8, the “retardation film” is based on a cyclic olefin-based resin stretched under a specific condition, and the wavelength dependence of its in is a value obtained by subjecting a retardation film peeled from a commercially available liquid crystal display to measurement. In addition, the magnitude of the retardation Re provided by each optical calculation is a value obtained by optimizing a parameter such as a film thickness or a stretching condition upon production of the retardation film.

In Table 8, the “polarizing plate protective layer” is based on a cellulose-based resin attached to a commercially available polarizing plate, and its retardation Rth and the wavelength dependence of its Δn are values obtained by subjecting only a polarizing plate protective layer peeled from a polarizing plate mounted on a commercially available liquid crystal display to measurement.

In Table 8, the term “driving liquid crystal” is a liquid crystal composition developed for a VA mode, and Table 8 shows the wavelength dependence of its Δn (difference between an extraordinary light refractive index ne and an ordinary light refractive index no). In addition, the retardation Rth of a VA cell is the product of the difference between the ordinary light refractive index no and the extraordinary light refractive index ne, and a cell thickness d, and the retardation Rth provided by each optical calculation is a value obtained by controlling the cell thickness d.

An optical device and the axial angle of the optical axis of a retardation film applied thereto, and its retardations Re and Rth, and the axial angle of the absorption axis of a polarizing plate comply with the definitions described in the foregoing. In addition, upon evaluation of an optical device such as an anti-counterfeit device or a liquid crystal display apparatus for its optical characteristics, an angle formed between the direction of the line of sight of an observer and the optical device is represented by polar coordinates (an azimuth angle (φ) and a polar angle (θ)), and its definition is illustrated in FIG. 3. A display surface in the anti-counterfeit device or liquid crystal display apparatus is an XY plane. When a plane including the direction of the line of sight is defined as an incidence plane, an angle formed between the X-axis and the incidence plane is the azimuth angle (φ), and an angle formed by the direction of the line of sight with respect to the Z-axis in the incidence plane is the polar angle (θ).

TABLE 8

| | Δn(450 nm)/ | Δn(650 nm)/ |
|---|---|---|
| | Δn(550 nm) | Δn(550 nm) |
| Driving liquid crystal | 1.05 | 0.96 |
| p A-plate (I): positive A-plate formed of | 1.19 | 0.87 |
| liquid crystalline polyimide containing | | |
| photoreactive group | | |
| Retardation film used in filter I or II | 1.01 | 1.00 |
| p A-plate (II): positive A-plate formed | 1.13 | 0.95 |
| of polymerizable liquid crystal | | |
| (homogeneously aligned) | | |
| n C-plate: negative C-plate formed of | 1.14 | 0.90 |
| polymerizable liquid crystal | | |
| (spirally aligned) | | |
| Polarizing plate protective layer | 0.60 | 1.23 |

### Example 4

### <Application as Anti-Counterfeit Device>

Defined as an anti-counterfeit device (1) is such an optical device that a retardation film of a p A-plate (p A-plate (I)) having wavelength dependence in conformity with Table 4 of Example 3 in which a plurality of patterns having different axial angles of optical axes or different magnitudes of retardations are formed with a liquid crystalline polyimide having a photoreactive group is formed on a mirror surface-shaped reflective plate. A plurality of patterns A-I to A-VI having different axial angles of optical axes or different magnitudes of retardations are formed in the retardation film by irradiating a coating film of a polyamic acid whose entire surface has a precisely uniform thickness with polarized ultraviolet light having an optimum orientation and an optimum irradiation energy intensity for each predetermined region together with masking with a photomask.

In addition, an optical device having the following structure is defined as an anti-counterfeit device (2). A retardation film of a p A-plate (p A-plate (II)) based on a homogeneously aligned polymerizable liquid crystal material in which the axial angle of an optical axis and the magnitude of a retardation are uniform is formed on the p A-plate (I) of the anti-counterfeit device (1). The retardation film is a film of a polymerizable liquid crystal material with immobilized homogenous alignment that is formed on the surface of the p A-plate (I), which has been rubbed in one direction so that a desired slow axis may be obtained, and whose thickness is optimized in accordance with a desired retardation. In addition, a plurality of patterns B-I to B-VI having different optical characteristics are formed in the film depending on the patterns A-I to A-VI formed in the p A-plate (I).

It should be noted that the structure of each of the anti-counterfeit device (1) and the anti-counterfeit device (2) is in conformity with the structure of FIG. 4 described in the foregoing. When any such anti-counterfeit device is observed without through any special filter, a chromaticity and a relative reflectance are substantially the same irrespective of the axial angle of the optical axis and the magnitude of the retardation in the retardation film, and hence a difference between the patterns described in the foregoing is indistinguishable.

When any such anti-counterfeit device is observed through a special filter, the chromaticity and the relative reflectance largely vary depending on the axial angle of the optical axis and the magnitude of the retardation in the retardation film, and hence the patterns described in the foregoing can be distinguished from each other. In addition, it was confirmed that diversity was caused in a series of changes of the chromaticity and the relative reflectance by installing the retardation film (p A-plate (II)) having a proper retardation Re or by changing the retardation Re of the retardation film of the special filter. It should be noted that a polarizing plate to which a retardation film having a specific magnitude of a retardation Re is attached is referred to as “special filter,” a polarizing plate to which a retardation film having a retardation of 138 nm is attached is defined as a filter I, and a polarizing plate to which a retardation film having a retardation of 530 nm is attached is defined as a filter II. Tables 9 and 10 show the optical characteristics of the respective anti-counterfeit devices and the results of their observation.

TABLE 9

| Observation | Anti-counterfeit device (1) | | A-I | A-II | A-III | A-IV | A-V | A-VI |
|---|---|---|---|---|---|---|---|---|
| condition | Retardation film pattern | | | | | | | |
| | p A-plate (I) | Retardation | 80 | 40 | 5 | 5 | 40 | 80 |
| | | (nm) λ = 550 nm | | | | | | |
| | | Optical axis (°) | 0 | 0 | 0 | 90 | 90 | 90 |
| Observation with | Chromaticity | x | 0.314 | 0.314 | 0.314 | 0.314 | 0.314 | 0.314 |
| no filter | | y | 0.330 | 0.330 | 0.330 | 0.330 | 0.330 | 0.330 |
| | | Tinge | Colorless | Colorless | Colorless | Colorless | Colorless | Colorless |
| | Relative reflectance (%) | | 100 | 100 | 100 | 100 | 100 | 100 |
| Observation with | Chromaticity | x | 0.239 | 0.178 | 0.183 | 0.287 | 0.414 | 0.323 |
| filter I | | y | 0.309 | 0.203 | 0.009 | 0.126 | 0.409 | 0.343 |
| | | Tinge | Light blue | Dark blue | Black | Black | Dark | Colorless |
| | | | | | | | yellow | |
| | Relative reflectance (%) | | 24 | 8 | 1 | 1 | 8 | 25 |
| Observation with | Chromaticity | x | 0.239 | 0.419 | 0.336 | 0.310 | 0.206 | 0.155 |
| filter II | | y | 0.309 | 0.485 | 0.515 | 0.496 | 0.348 | 0.181 |
| | | Tinge | Pink | Yellow | Green | Green | Bluish | Blue |
| | | | | | | | green | |

| | | | | | | |
|---|---|---|---|---|---|---|
| Relative reflectance (%) | 24 | 31 | 32 | 31 | 22 | 9 |

TABLE 10

| Observation | Anti-counterfeit device (2) | | B-I | B-II | B-III | B-IV | B-V | B-VI |
|---|---|---|---|---|---|---|---|---|
| condition | Retardation film pattern | | | | | | | |
| | p A-plate (II) | Retardation | 390 | | | | | |
| | | (nm) λ = 550 nm | | | | | | |
| | | Optical axis (°) | 0 | | | | | |
| | p A-plate (I) | Retardation | 80 | 40 | 5 | 5 | 40 | 80 |
| | | (nm) λ = 550 nm | | | | | | |
| | | Optical axis (°) | 0 | 0 | 0 | 90 | 90 | 90 |
| Observation with | Chromaticity | x | 0.313 | 0.313 | 0.313 | 0.314 | 0.314 | 0.314 |
| no filter | | y | 0.330 | 0.330 | 0.330 | 0.330 | 0.330 | 0.330 |
| | | Tinge | Colorless | Colorless | Colorless | Colorless | Colorless | Colorless |
| | Relative reflectance (%) | | 100 | 100 | 100 | 99 | 99 | 99 |
| Observation with | Chromaticity | x | 0.383 | 0.361 | 0.314 | 0.297 | 0.196 | 0.157 |
| filter I | | y | 0.309 | 0.400 | 0.504 | 0.520 | 0.466 | 0.233 |
| | | Tinge | Pink | Yellow | Green | Green | Dark green | Blue |

| | | | | | | |
|---|---|---|---|---|---|---|
| Relative reflectance (%) | 24 | 29 | 28 | 27 | 19 | 9 |

In each of the filters I and II, the retardation film and the polarizing plate are attached to each other so that the orientation of the absorption axis of the polarizing plate may be 45° when the orientation of the optical axis of the retardation film is set to 0°. The observation with any such filter is performed by placing the filter so that the retardation film may be on the side of an anti-counterfeit device, and the chromaticity and the relative reflectance are values to be observed at such a position that each of the azimuth angle and the polar angle is 0°.

As is apparent from the foregoing, the retardation film of the present invention can construct such an anti-counterfeit device that a specific color is observed through the filter. In addition, the retardation film of the present invention can construct the following anti-counterfeit device in which an additionally high-definition image is observed. When the coating film of the polyamic acid solution is irradiated with light beams with their kinds, polarization directions, and irradiation energy intensities appropriately adjusted through a mask having an opening corresponding to part of a letter or figure, the letter or figure based on a combination of their specific colors is observed through the filter.

### Example 5

<Patterned Retardation Film Whose Retardation or Optical Axis is Optimized for Each of Blue, Green, and Red Pixels, and Characteristic of Circularly Polarizing Plate Obtained by Combining ¼λ Plate Based on Composite Retardation Film Including the Retardation Film and Polarizing Plate>

A circularly polarizing plate is produced by combining a ¼λ plate and a polarizing plate. The circularly polarizing plate is evaluated for its performance by installing the plate on a reflective plate and calculating the reflectance of reflected light. Further, the pattern of color filter layers having spectral transmittances corresponding to blue, green, and red colors is formed between the reflective plate and the polarizing plate on the assumption that the circularly polarizing plate is utilized in a reflective liquid crystal display apparatus or a semitransmission-type liquid crystal display apparatus.

The case where the ¼λ plate is the retardation film of an A-plate (p A-plate (II)) based on a homogeneously aligned polymerizable liquid crystal in which the axial angle of an optical axis and the magnitude of a retardation are uniform irrespective of blue, red, and green pixels is defined as Comparative Example 1.

The case where the ¼λ plate is the retardation film (p A-plate (I)) whose pattern is formed by optimizing the magnitude of a retardation with a liquid crystalline polyimide containing a photoreactive group for each of the blue, red, and green pixels is defined as Invention Example 1. Here, a pattern in which the magnitude of the retardation is optimized for each of the blue, green, and red pixels is formed in the retardation film (p A-plate (I)) by irradiating a coating film of a polyamic acid whose entire surface has a precisely uniform thickness with polarized ultraviolet light while changing its irradiation energy intensity so that the magnitude of the retardation may be optimized for each of the blue, green, and red pixels together with masking with a photomask.

The case where the ¼λ plate is a combination of the retardation film (p A-plate (1)) whose pattern is formed by optimizing the axial angle of an optical axis or the magnitude of a retardation with the liquid crystalline polyimide containing a photoreactive group for each of the blue, red, and green pixels and the retardation film of an A-plate (p A-plate (II)) based on the homogeneously aligned polymerizable liquid crystal in which the axial angle of the optical axis and the magnitude of the retardation are uniform is defined as Invention Example 2. Here, a pattern in which the orientation of the optical axis and the magnitude of the retardation are optimized for each of the blue, green, and red pixels is formed in the retardation film (p A-plate (I)) by irradiating a coating film of a polyamic acid whose entire surface has a precisely uniform thickness with polarized ultraviolet light having an optimum orientation and an optimum irradiation energy intensity for each of the blue, green, and red pixels together with masking with a photomask. In addition, the retardation film (p A-plate (II)) is a film of a polymerizable liquid crystal material with immobilized homogenous alignment that is formed on the surface (reflective plate side) of the retardation film (p A-plate (I)), which has been rubbed in one direction so that a desired slow axis may be obtained, and whose thickness is optimized in accordance with its retardation.

A table below shows the orientation of the optical axis and the retardation Re corresponding to each colored layer in the p A-plate (I), the orientation of the optical axis and the retardation Re corresponding to each colored layer in the p A-plate (II), the retardation Rth in the thickness direction of the polarizing plate protective layer, the orientation (45°) of the absorption axis of the polarizing plate, and the reflectance at such observation position that the azimuth angle and the polar angle are 0° in each of the examples. In addition, FIG. 21 shows the spectral transmittance characteristics of Comparative Example 1 and Invention Example 2 described in the foregoing.

TABLE 11

| | | Construction of optical component | | | | | |
|---|---|---|---|---|---|---|---|
| | | ←Observer side | | | | | |
| | | | Polarizing | | | | |
| | | | plate | | | | Reflectance |
| | | Absorption axis of | protective | p A-plate | | | (relative value) |
| | | polarizing plate | layer | (I) | p A-plate (II) | | Azimuth angle = 0°, |
| Example | | (degree(s)) | Rth | Re | Re | Reflective plate | polar angle = 0° |
| Comparative | Pixel (blue) | 45 | 24 nm | | 0° | Reflective plate | 1.97E−03 |
| Example 1 | λ = 450 nm | | | | 156 nm | | |
| | Pixel (green) | | 40 nm | | 0° | | |
| | λ = 550 nm | | | | 138 nm | | |
| | Pixel (red) | | 49 nm | | 0° | | |
| | λ = 650 nm | | | | 131 nm | | |
| Invention | Pixel (blue) | 45 | 24 nm | 0° | | Reflective plate | 6.57E−04 |
| Example 1 | λ = 450 nm | | | 130 nm | | | |
| | Pixel (green) | | 40 nm | 0° | | | |
| | λ = 550 nm | | | 131 nm | | | |
| | Pixel (red) | | 49 nm | 0° | | | |
| | λ = 650 nm | | | 149 nm | | | |
| Invention | Pixel (blue) | 45 | 24 nm | 90° | 0° | Reflective plate | 4.33E−04 |
| Example 2 | λ = 450 nm | | | 28 nm | 156 nm | | |
| | Pixel (green) | | 40 nm | 90° | 0° | | |
| | λ = 550 nm | | | 5 nm | 138 nm | | |
| | Pixel (red) | | 49 nm | 0° | 0° | | |
| | λ = 650 nm | | | 22 nm | 131 nm | | |

As shown in Table 11, the reflectance of Comparative Example 1 was 1.97×10⁻³, the reflectance of Invention Example 1 was 6.57×10⁻⁴, and the reflectance of Invention Example 2 was 4.33×10⁻⁴. In the case where the retardation film whose pattern is formed by optimizing the axial angle of an optical axis or the magnitude of a retardation with the liquid crystalline polyimide containing a photoreactive group for each of the blue, red, and green pixels is utilized as a ¼λ plate (Invention Example 1 or 2), as shown in Table 11, a lower reflectance than that in the case where the retardation film in which the axial angle of an optical axis and a retardation are uniform irrespective of the blue, red, and green pixels is used as a ¼λ plate (Comparative Example 1) is obtained. This is because the reflectance is suppressed in a wider wavelength range as shown in FIG. 21. In addition, it is apparent that a higher contrast ratio is obtained in a reflective liquid crystal display apparatus or semitransmission-type liquid crystal display apparatus utilizing the retardation film whose pattern is formed by optimizing the axial angle of an optical axis or the magnitude of a retardation with the liquid crystalline polyimide containing a photoreactive group for each of the blue, red, and green pixels as a ¼λ plate.

### Example 6

<Patterned Retardation Film in which Retardation or Optical Axis is Optimized for Each of Blue, Green, and Red Pixels, and Improvement in Viewing Angle Characteristic of VA Mode with Composite Retardation Film Including the Retardation Film>

A transmission-type liquid crystal display apparatus according to a VA mode to be optically compensated with a positive A-plate and a negative C-plate was evaluated. The apparatus was evaluated for its luminance (relative value) in a viewing angle direction (having an azimuth angle of 45° and a polar angle of 70°) in a dark state in which no voltage was applied. As its luminance reduces, the liquid crystal display apparatus is regarded as being more excellent in performance because the apparatus obtains a higher contrast ratio.

The pattern of color filter layers having spectral transmittances corresponding to blue, green, and red colors is formed. Further, each of the p A-plate (I), the p A-plate (II), and the n C-plate is formed on a color filter layer on the side of a driving liquid crystal medium.

The case where the positive A-plate is the retardation film of an A-plate (p A-plate (II)) based on a homogeneously aligned polymerizable liquid crystal in which the axial angle of an optical axis and the magnitude of a retardation are uniform irrespective of blue, red, and green pixels is defined as Comparative Examples 2 and 3.

The case where the positive A-plate is the retardation film (p A-plate (I)) whose pattern is formed by optimizing the magnitude of a retardation with a liquid crystalline polyimide containing a photoreactive group is defined as Invention Example 5. Here, a pattern in which the magnitude of the retardation is optimized for each of the blue, green, and red pixels is formed in the retardation film (p A-plate (I)) by irradiating a coating film of a polyamic acid whose entire surface has a precisely uniform thickness with polarized ultraviolet light while changing its irradiation energy intensity so that the magnitude of the retardation may be optimized for each of the blue, green, and red pixels together with masking with a photomask.

The case where the positive A-plate is a combination of the retardation film (p A-plate (I)) whose pattern is formed by optimizing the axial angle of an optical axis or the magnitude of a retardation with the liquid crystalline polyimide containing a photoreactive group for each of the blue, red, and green pixels and the retardation film of an A-plate (p A-plate (II)) based on the homogeneously aligned polymerizable liquid crystal in which the axial angle of the optical axis and the magnitude of the retardation are uniform is defined as Invention Examples 3, 4, and 6. Here, a pattern in which the orientation of the optical axis and the magnitude of the retardation are optimized for each of the blue, green, and red pixels is formed in the retardation film (p A-plate (I)) by irradiating a coating film of a polyamic acid whose entire surface has a precisely uniform thickness with polarized ultraviolet light having an optimum orientation and an optimum irradiation energy intensity for each of the blue, green, and red pixels together with masking with a photomask. In addition, the retardation film (p A-plate (II)) is a film of a polymerizable liquid crystal material with immobilized homogenous alignment that is formed on the surface (polarizing plate protective layer side or driving liquid crystal side) of the retardation film (p A-plate (I)), which has been rubbed in one direction so that a desired slow axis may be obtained, and whose thickness is optimized in accordance with its retardation.

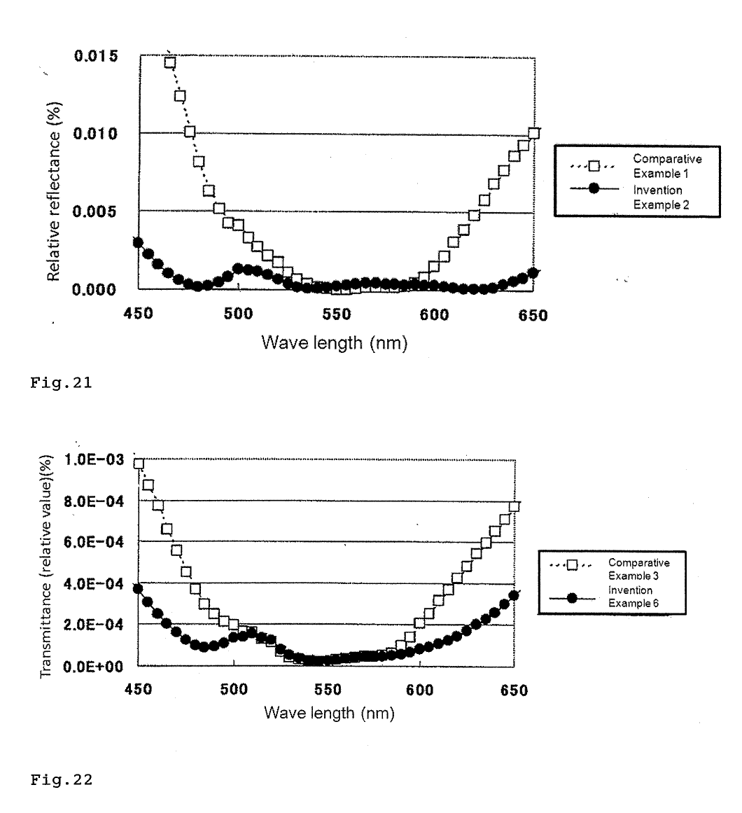

A table below shows, for each of the examples, the orientations of the absorption axes of the first and second polarizing plates, the Rth's of the first and second polarizing plate protective layers, the VA cell, and the n C-plate, the Re of each p A-plate, and the luminance in the viewing angle direction in each example. In addition, FIG. 22 shows the spectral transmittance characteristics of Comparative Example 3 and Invention Example 6. The Rth of the VA cell is determined from the equation (no-ne)×d where no and ne represent the refractive indices of the driving liquid crystal layer, and d represents the thickness of the driving liquid crystal layer.

TABLE 12

| | | | | | | | | | | | Luminance |
|---|---|---|---|---|---|---|---|---|---|---|---|
| | ←Observer side Construction of optical component Light source side→ | | | | | | | | | | (relative |
| | | Absorption | Polarizing | p A- | p A- | p A- | | | Polarizing | Absorption | value) |
| | | axis of | plate | plate (I) | plate (II) | plate (I) | | | plate | axis of | Azimuth |
| | | polarizing | protective | Optical | Optical | Optical | | | protective | polarizing | angle = 45°, |
| | | plate | layer | axis | axis | axis | n C-plate | VA cell | layer | plate | polar |
| Example | | (degree(s)) | Rth | Re | Re | Re | Rth | Rth | Rth | (degree(s)) | angle = 70° |
| Comparative | Pixel (blue) | 0 | 24 nm | | 90° | | 221 nm | −335 nm | 24 nm | 90 | 1.37E−02 |
| Example 2 | λ = 450 nm | | | | 113 nm | | | | | | |
| | Pixel | | 40 nm | | 90° | | 194 nm | −320 nm | 40 nm | | |
| | (green) | | | | | | | | | | |
| | λ = 550 nm | | | | 100 nm | | | | | | |
| | Pixel (red) | | 49 nm | | 90° | | 174 nm | −306 nm | 49 nm | | |
| | λ = 650 nm | | | | 95 nm | | | | | | |
| Invention | Pixel (blue) | 0 | 24 nm | 0° | 90° | | 221 nm | −335 nm | 24 nm | 90 | 1.18E−04 |
| Example 3 | λ = 450 nm | | | 67 nm | 113 nm | | | | | | |
| | Pixel | | 40 nm | 0° | 90° | | 194 nm | −320 nm | 40 nm | | |
| | (green) | | | | | | | | | | |
| | λ = 550 nm | | | 0 nm | 100 nm | | | | | | |
| | Pixel (red) | | 49 nm | 90° | 90° | | 174 nm | −306 nm | 49 nm | | |
| | λ = 650 nm | | | 24 nm | 95 nm | | | | | | |
| Comparative | Pixel (blue) | 0 | 0 nm | | 90° | | 287 nm | −335 nm | 0 nm | 90 | 1.21E−04 |
| Example 3 | λ = 450 nm | | | | 158 nm | | | | | | |
| | Pixel | | | | 90° | | 252 nm | −320 nm | | | |
| | (green) | | | | | | | | | | |
| | λ = 550 nm | | | | 140 nm | | | | | | |
| | Pixel (red) | | | | 90° | | 226 nm | −306 nm | | | |
| | λ = 650 nm | | | | 133 nm | | | | | | |
| Invention | Pixel (blue) | 0 | 0 nm | 0° | 90° | | 287 nm | −335 nm | 0 nm | 90 | 7.50E−05 |
| Example 4 | λ = 450 nm | | | 62 nm | 158 nm | | | | | | |
| | Pixel | | | 0° | 90° | | 252 nm | −320 nm | | | |
| | (green) | | | | | | | | | | |
| | λ = 550 nm | | | 0 nm | 140 nm | | | | | | |
| | Pixel (red) | | | 90° | 90° | | 226 nm | −306 nm | | | |
| | λ = 650 nm | | | 32 nm | 133 nm | | | | | | |
| Invention | Pixel (blue) | 0 | 0 nm | 90° | | | 287 nm | −335 nm | 0 nm | 90 | 7.30E−05 |
| Example 5 | λ = 450 nm | | | 143 nm | | | | | | | |
| | Pixel | | | 90° | | | 252 nm | −320 nm | | | |
| | (green) | | | | | | | | | | |
| | λ = 550 nm | | | 140 nm | | | | | | | |
| | Pixel (red) | | | 90° | | | 226 nm | −306 nm | | | |
| | λ = 650 nm | | | 154 nm | | | | | | | |
| Invention | Pixel (blue) | 0 | 0 nm | | 90° | 0° | 287 nm | −335 nm | 0 nm | 90 | 6.00E−05 |
| Example 6 | λ = 450 nm | | | | 158 nm | 14 nm | | | | | |
| | Pixel | | | | 90° | 0° | 252 nm | −320 nm | | | |
| | (green) | | | | | | | | | | |
| | λ = 550 nm | | | | 140 nm | 0 nm | | | | | |
| | Pixel (red) | | | | 90° | 90° | 226 nm | −306 nm | | | |
| | λ = 650 nm | | | | 133 nm | 24 nm | | | | | |

As shown in Table 12, in the case where the retardation film whose pattern is formed by optimizing the axial angle of an optical axis or the magnitude of a retardation with the liquid crystalline polyimide containing a photoreactive group for each of the blue, red, and green pixels is utilized as a positive A-plate (Invention Example 3 for Comparative Example 2, or Invention Example 4, 5, or 6 for Comparative Example 3), a lower luminance than that in the case where the retardation film in which the axial angle of an optical axis and a retardation are uniform irrespective of the blue, red, and green pixels is used as a positive A-plate (Comparative Example 2 or 3) is obtained. This is because the transmittance is suppressed in a wider wavelength range as shown in FIG. 22.

### INDUSTRIAL APPLICABILITY

The retardation film of the present invention is obtained by optical alignment, that is, the application of light in a specific polarization state because the film uses a liquid crystalline polyimide film having a photoreactive group. In addition, the retardation film can be provided with smaller numbers of members and steps than those of a conventional production method for a retardation film based on an alignment film and a liquid crystalline material typified by a polymerizable liquid crystal material.

In addition, the axial angle of the optical axis, and magnitude of the birefringence, of the retardation film of the present invention can be adjusted by controlling the polarization state, and irradiation energy intensity, of light to be applied. Accordingly, its optical axis or retardation can be changed for each predetermined region by using a masking approach in combination.

Further, a retardation film in which regions different from each other in optical characteristic, i.e., an optical axis or a retardation are patterned, and a liquid crystal display apparatus and an optical device typified by an anti-counterfeit device each using the retardation film can be provided by additionally simplified production steps.

### REFERENCE SIGNS LIST

1 axial angle of optical axis
2 axial angle of absorption axis
3 incidence plane
4 azimuth angle
5 polar angle
7 reflective substrate
8, 11, 13, 16, 22, 39, 44, 49, 51 retardation film
8a to 8e, 16a to 16c, 22a, 22b region
9 polarizing filter
10, 17, 21, 43, 46 polarizing plate
10a orientation of absorption axis
11a orientation of optical axis
12 observer
14 substrate
15 selective reflective filth
18 support
19 adhesive layer
20 image display apparatus
20a odd-numbered line
20b even-numbered line
23a, 23b polarizing filter
24a left eye
24b right eye
31 plane substrate
32 switching device
33 insulating film
34 reflective electrode
35, 37 liquid crystal alignment film
36 liquid crystal layer
38, 48 transparent electrode
40 overcoat layer
41 color filter layer
42, 47 transparent substrate
45 backlight unit
50 cell thickness-adjusting layer

1. A retardation film, being formed of a material containing a polyimide that has a photoreactive group and shows liquid crystallinity.

2. The retardation film according to claim 1, wherein a pattern formed of at least two regions different from each other in one or both of an orientation of an optical axis and a magnitude of a retardation is formed.

3. The retardation film according to claim 2, wherein the film is obtained by irradiation with light beams in different polarization states.

4. The retardation film according to claim 2, wherein the film is obtained by irradiation with light in an arbitrary polarization state at different illuminances or different irradiation energy intensities.

5. The retardation film according to claim 2, wherein the film is obtained by forming different thicknesses.

6. The retardation film according to claim 2, wherein the film is obtained by combining at least two of the following approaches:
(1) irradiation with light beams in different polarization states;
(2) irradiation with light having an arbitrary polarization state at different illuminances or different irradiation energy intensities; and
(3) formation of different thicknesses.

7. The retardation film according to claim 1, wherein the liquid crystalline polyimide film is a polyimide film caused to express optical anisotropy by photoirradiation and baking of a polyamic acid that has a photoreactive group and expresses liquid crystallinity by being imidated.

8. An optical device, comprising the retardation film according to claim 1.

9. The optical device according to claim 8, comprising:
a patterned retardation film in which a pattern formed of at least two regions different from each other in one or both of an orientation of an optical axis and a magnitude of a retardation is formed; and
a non-patterned retardation film in which an orientation of an optical axis and a magnitude of a retardation are uniform,
wherein the patterned retardation film is the retardation film being formed of a material containing a polyimide that has a photoreactive group and shows liquid crystallinity.

10. The optical device according to claim 9, wherein at least one layer of the non-patterned retardation film is a film in which an alignment state of a liquid crystal compound having a polymerizable functional group is immobilized by crosslinking or polymerization of the liquid crystal compound.

11. The optical device according to claim 10, wherein the non-patterned retardation film in which the alignment state of the liquid crystal compound is immobilized by the crosslinking or the polymerization is directly formed on the patterned retardation film.

12. The optical device according to claim 11, wherein:
the patterned retardation film is a patterned retardation film whose surface is rubbed or is irradiated with ultraviolet light; and
the non-patterned retardation film in which the alignment state of the liquid crystal compound is immobilized by the crosslinking or the polymerization is formed thereon.

13. The optical device according to claim 10, wherein the alignment state of the liquid crystal compound is horizontal alignment.

14. The optical device according to claim 10, wherein the alignment state of the liquid crystal compound is spray alignment or hybrid alignment.

15. The optical device according to claim 10, wherein the alignment state of the liquid crystal compound is vertical alignment.

16. The optical device according to claim 10, wherein the alignment state of the liquid crystal compound is spirally distorted alignment.

17. The optical device according to claim 8, wherein the element is an anti-counterfeit device.

18. A display apparatus, comprising the retardation film according to claim 1.

19. A liquid crystal display apparatus, comprising the retardation film according to claim 1.

20. The liquid crystal display apparatus according to claim 19, further comprising a color filter for selectively transmitting light in a specific wavelength range, wherein:
the color filter has color filter layers for selectively and independently transmitting light beams in two or more specific wavelength ranges, and a retardation film provided in correspondence with the color filter layers for each pixel; and
the retardation film is the retardation film being formed of a material containing a polymide that has a photoreactive and shows liquid crystallinity.

21. The liquid crystal display apparatus according to claim 20, wherein the retardation film is a retardation film in which a pattern formed of two or more regions different from each other in one or both of an orientation of an optical axis and a magnitude of a retardation is formed in correspondence with respective regions of the color filter layers for transmitting the light beams in the specific wavelength ranges.

22. The liquid crystal display apparatus according to claim 20, the apparatus being a semitransmission-type liquid crystal display apparatus having a region provided with a reflective plate and a region free of being provided with any reflective plate for each pixel, wherein the retardation film is a retardation film in which a pattern formed of two or more regions different from each other in one or both of an orientation of an optical axis and a magnitude of a retardation is formed in correspondence with the region provided with the reflective plate and the region free of being provided with any reflective plate.

23. The liquid crystal display apparatus according to claim 22, wherein the retardation film is a retardation film in which a pattern formed of two or more regions different from each other in one or both of an orientation of an optical axis and a magnitude of a retardation is formed in further correspondence with respective regions of the color filter layers for transmitting the light beams in the specific wavelength ranges.
